(19) United States
(12) Patent Application Publication
(10) Pub. No.: US 2014/0093174 A1
(43) Pub. Date: Apr. 3, 2014

(54) SYSTEMS AND METHODS FOR IMAGE MANAGEMENT

(71) Applicant: CANON KABUSHIKI KAISHA, Tokyo (JP)

(72) Inventors: Liyan Zhang, Irvine, CA (US); Bradley Scott Denney, Irvine, CA (US); Juwei Lu, Irvine, CA (US)

(73) Assignee: CANON KABUSHIKI KAISHA, Tokyo (JP)

(21) Appl. No.: 13/629,948

(22) Filed: Sep. 28, 2012

(51) Int. Cl. G06K 9/46

(52) U.S. Cl. 382/190

(57) ABSTRACT

Systems and methods for organizing images extract low-level features from an image of a collection of images of a specified event, wherein the low-level features include visual characteristics calculated from the image pixel data, and wherein the specified event includes two or more sub-events; extract a high-level feature from the image, wherein the high-level feature includes characteristics calculated at least in part from one or more of the low-level features; identify a sub-events in the image based on the high-level feature and a predetermined model of the specified event, wherein the predetermined model describes a relationship between two or more sub-events; and annotate the image based on the identified sub-event.

### BACKGROUND

1. Field

The present disclosure generally relates to image management, including image annotation.

2. Background

Collections of images may include thousands or millions of images. For example, thousands of images may be taken of an event, such as a wedding, a sporting event, a graduation ceremony, a birthday party, etc. Human browsing of such a large collection of images may be very time consuming. For example, if a human browses just a thousand images and spends only fifteen seconds on each image, the human will spend over four hours browsing the images. Thus, human review of large collections (e.g., hundreds, thousands, tens of thousands, millions) of images may not be feasible.

### SUMMARY

In one embodiment, a method comprises extracting low-level features from an image of a collection of images of a specified event, wherein the low-level features include visual characteristics calculated from the image pixel data, and wherein the specified event includes two or more sub-events; extracting a high-level feature from the image, wherein the high-level feature includes characteristics calculated at least in part from one or more of the low-level features of the image; identifying a sub-event in the image based on the high-level feature and a predetermined model of the specified event, wherein the predetermined model describes a relationship between two or more sub-events; and annotating the image based on the identified sub-event.

In one embodiment, a system for organizing images comprises at least one computer-readable medium configured to store images, and one or more processors configured to cause the system to extract low-level features from a collection of images of an event, wherein the specified event includes one or more sub-events; extract a high-level feature from one or more images based on the low-level features; identify two or more sub-events corresponding to two or more images in the collection of images based on the high-level feature and a predetermined model of the event, wherein the predetermined model defines the two or more sub-events; and label the two or more images based on the recognized corresponding sub-events.

In one embodiment, one or more computer-readable media store instructions that, when executed by one or more computing devices, cause the one or more computing devices to perform operations comprising quantifying low-level features of images of a collection of images of an event, quantifying one or more high-level features of the images based on the low-level features, and associating images with respective sub-events based on the one or more high-level features of the images and a predetermined model of the event that defines the sub-events.

### BRIEF DESCRIPTION OF THE DRAWINGS

FIG. 1 illustrates an example embodiment of the flow of operations in an image management system.

FIG. 2 illustrates an example embodiment of an image management system.

FIG. 3 illustrates an example embodiment of the components of an image management system.

FIG. 4 illustrates example embodiments of images, features, and events.

FIG. 5 illustrates example embodiments of event models.

FIG. 6 illustrates example embodiments of Hidden Markov Models.

FIG. 7 illustrates an example embodiment of a Viterbi algorithm.

FIG. 8 illustrates an example embodiment of a method for labeling images.

FIG. 9 illustrates an example embodiment of transition probabilities and observed state probabilities for an event model.

FIG. 10 illustrates an example embodiment of transition probabilities and observed state probabilities for an event model.

FIG. 11 illustrates an example embodiment of a method for labeling images.

FIG. 12 illustrates an example embodiment of a method for labeling images.

FIG. 13 illustrates an example embodiment of an image management system.

FIG. 14A illustrates an example embodiment of an image management system.

FIG. 14B illustrates an example embodiment of an image management system.

FIG. 15 illustrates an example embodiment of the flow of operations in a recommendation system.

FIG. 16 illustrates an example embodiment of the flow of operations in a recommendation system.

FIG. 17 illustrates an example embodiment of the flow of operations in a recommendation system.

FIG. 18A illustrates an example embodiment of a recommendation system.

FIG. 18B illustrates an example embodiment of a recommendation system.

FIG. 19 illustrates an example embodiment of a method for generating image recommendations and examples.

FIG. 20 illustrates an example embodiment of an image summarization method.

FIG. 21 illustrates an example embodiment of a method for generating a score for a representative image.

FIG. 22 illustrates an example embodiment of a method for determining the sub-event related to the images in a cluster of images.

FIG. 23A illustrates an example embodiment of the generation of an estimated subjective score based on an image collection for a sub-event.

FIG. 23B illustrates an example embodiment of the generation of a facial expression score based on a normal face.

FIG. 24 illustrates an example embodiment of a method for selecting representative images.

FIG. 25A illustrates an example embodiment of an image management system.

FIG. 25B illustrates an example embodiment of an image management system.

### DESCRIPTION

The following disclosure describes certain explanatory embodiments. Additionally, the explanatory embodiments may include several novel features, and a particular feature may not be essential to practice the systems and methods described herein.

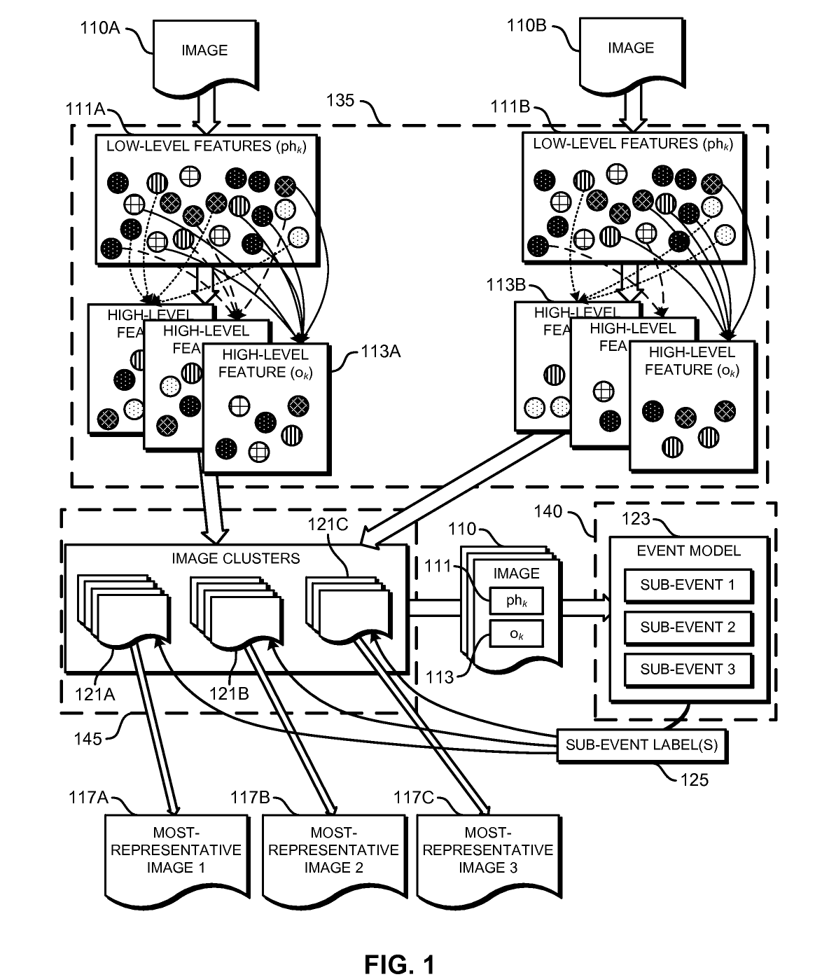

FIG. 1 is a block diagram that illustrates an example embodiment of the flow of operations in an image management system. The system includes one or more computing devices that include a feature analysis module 135, an organization module 145, and an annotation module 140. The modules and images are stored on one or more computer-readable media. Modules include logic, computer-readable data, and/or computer-executable instructions, and may be implemented in software (e.g., Assembly, C, C++, C#, Java, BASIC, Perl, Visual Basic), firmware, and/or hardware. In some embodiments, the system includes additional or fewer modules, the modules are combined into fewer modules, or the modules are divided into more modules. Though the computing device or computing devices that execute a module actually perform the operations, for purposes of description a module may be described as performing one or more operations.

Generally, the system extracts low-level features 111 from images 110; extracts high-level features 113 based on the low-level features 111; clusters the images 110 to generate image clusters 121; generates labels 125 for the images 110 based on the low-level features 111, the high-level features 113, and an event model 123 that includes one or more sub-events; and selects one or more representative images 117 for each cluster 121.

In FIG. 1, the feature analysis module 135 (i.e., the computing device implementing the module, as described above) extracts the low-level features 111A (low-level features are also represented herein by “ph”) from a first image 110A. Next, the feature analysis module 135 extracts high-level features 113A (high-level features are also represented herein by “o”) from the first image 110A based on one or more of the low-level features 111A and/or data included with the first image 110A (e.g., metadata, such as EXIF data). For example, the low-level features 110A may be analyzed to identify the high level features 113A. These operations are performed for additional images, including a second image 110B. The corresponding low-level features 111B are extracted from the second image 110B, and the high level-features 113B are extracted from the second image 110B based on the low-level features 111B. Though only two images are shown in FIG. 1, the same operations may be performed for more images.

Next, the organization module 145 clusters the images (including the first image 110A and the second image 110B) to generate image clusters 121, which include a first cluster 121A, a second cluster 121B, and a third cluster 121C. Other embodiments may include more or fewer clusters. The organization module 145 may generate the clusters 121 based on the high-level features, the low-level features, or both.

Then, the annotation module 140 generates sub-event labels 125 for an image 110 based on the images 110 (including their respective low-level features 111 and high-level features 113) and an event model 123. The images 110 may be the images in a selected cluster 121, for example cluster 121A, and the sub-event labels 125 generated based on a cluster 121 may be applied to all images in the cluster 121. The event model 123 includes three sub-events: sub-event 1, sub-event 2, and sub-event 3. Some embodiments may include more or fewer sub-events, and a sub-event label 125 may identify a corresponding sub-event.

Additionally, one or more representative images 117 (e.g., most-representative images) may be selected for each of the image clusters 121. For example, most-representative image 1 117A is the selected most-representative image for cluster 121A, most-representative image 2 117B is the selected most-representative image for cluster 121B, and most-representative image 3 117C is the selected most-representative image for cluster 121C.

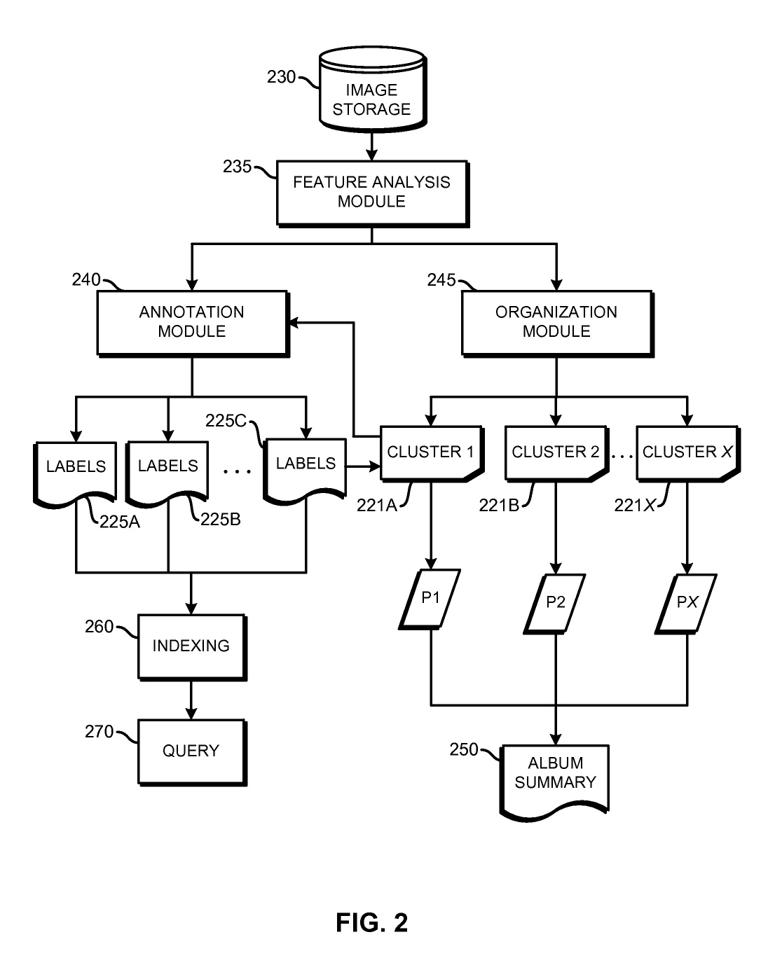

FIG. 2 is a block diagram that illustrates an example embodiment of an image management system. The system includes an annotation module 240, an organization module 245, a feature analysis module 235, and image storage 230, which includes one or more computer-readable media that store images. The images may include images from a camera that were collected for a predefined event. Text information describing the contents is not necessarily provided with the images. However, in some embodiments, some EXIF information, such as image capture time, camera model, flash settings, etc., may be provided with the images. The organization module 245 groups images into clusters 221 (e.g., cluster 1 221A, cluster 2 221B, . . . , cluster X 221X) and selects one or more representative images (e.g., P1, . . . , P2, . . . , PX) for each of the clusters 221. The annotation module 240 extracts features from images, identifies sub-events associated with the images, and adds corresponding labels 225 (e.g., labels 225A-C) that describe the content of the images to the images. The annotation module 240 may perform the extraction and labeling on a group scale. For example, the annotation module 240 may receive the images in cluster 1 221A, extract the features in the images in cluster 1 221A, and assign one or more labels 225 to all the images in cluster 1 221A based on the collective features. An indexing module 260 may facilitate fast and efficient queries by indexing the images. Additionally, a query module 270 may receive queries and search the images for the query results. Also, the images and their assigned labels 225 are added to an album, and some representative images (P1, P2, . . . , PX) for each cluster may be selected and added to an album summary 250.

To select the representative images (P1, P2, . . . , PX), the organization module 245 may use some low-level and high-level features to compute image similarities in order to construct an image relationship graph. The organization module 245 implements one or more clustering algorithms, such as affinity propagation, for example, to cluster images into several clusters 221 based on the low-level features and or the high-level features. Within each cluster 221, images share similar visual features and semantic information (e.g., sub-event labels). To select the most-representative images in each cluster 221, an image relationship graph inside each cluster 221 may be constructed, and the images may be ranked. In some embodiments, the images are ranked using a random walk-like process, for example as described in U.S. application Ser. No. 12/906,107 by Bradley Scott Denney and Anoop Korattikara-Balan, and the top-ranked images for each cluster 221 are considered to be the most-representative images. Furthermore, with the labels 225 obtained from the annotation module 240, the album 250 may be summarized with representative images (P1, P2, . . . , PX) along with the labels 225.

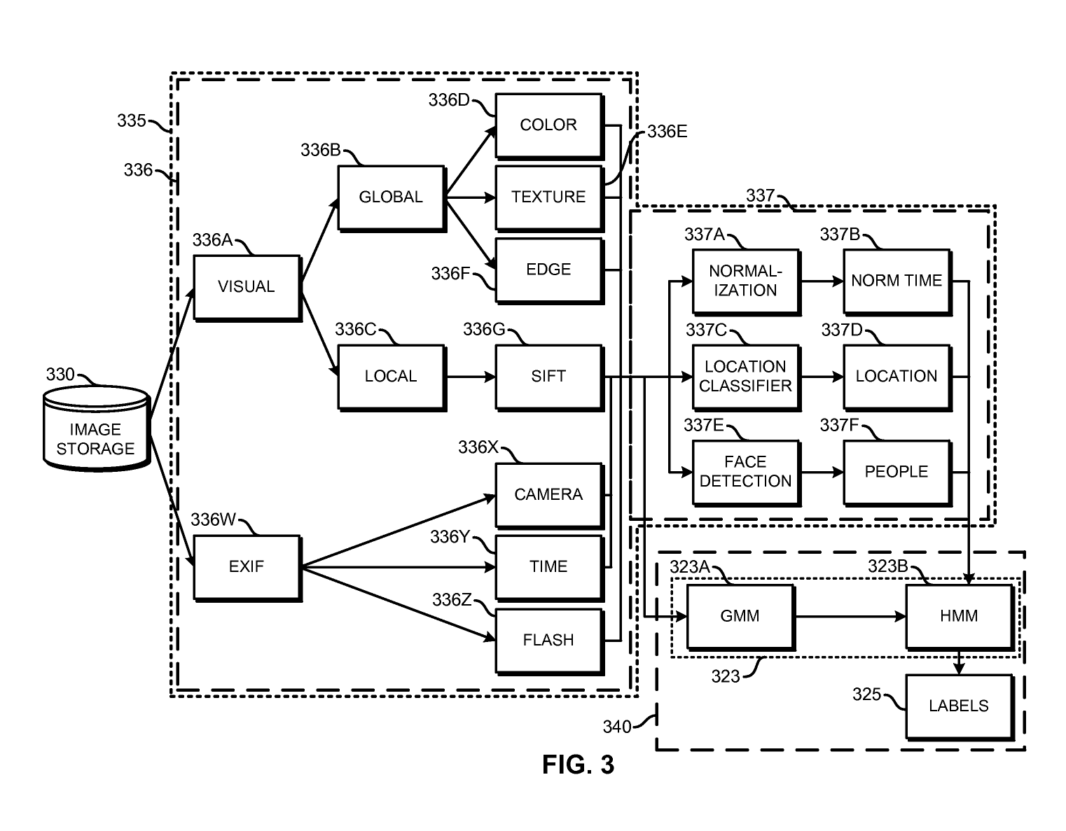

FIG. 3 illustrates an example embodiment of the components of an image management system. The system includes a feature analysis module 335, an annotation module 340, and image storage 330. The feature analysis module 335 includes a low-level feature extraction module 336 and a high-level feature extraction module 337. The images from the image storage 330 are input to the low-level feature extraction module 336, which extracts the low-level features. The low-level features associated with each image may include a variety of features computed from the image (e.g., SIFT, SURF, CHoG) and additional information, for example corresponding file and folder names, comments, tags, and EXIF information. The low-level feature extraction module 336 includes a visual feature extraction module 336A and an EXIF feature extraction module 336W. The visual feature extraction module 336A is divided into a global feature extraction module 336B and a local feature extraction module 336C. Global features include color 336D, texture 336E, and edge 336F, and local features include SIFT features 336G, though other global and local features may be included, for example, a 64-dimensional color histogram, a 144-dimensional color correlogram, a 73-dimensional edge direction histogram, a 128-dimensional wavelet texture, a 225-dimensional block-wise color moments extracted over 5-by-5 fixed grid partitions, a 500-dimensional bag-of-words based on SIFT descriptors, SURF features, CHoG features, etc. Also, in this example embodiment the EXIF information includes image capture time 336Y, camera model 336X, and flash settings 336Z, though some embodiments include additional EXIF information, for example ISO, F-stop, exposure time, GPS location, etc.

High-level features generally include “when”, “where”, “who”, and “what”, which refer to time, location, people and objects involved, and related activities. By extracting high-level information from an image and its associated data, the sub-event shown in an image may be determined. For example, an image is analyzed and the feature analysis module 335 and the annotation module 340 detect that the image was shot during a wedding ceremony in a church, the people involved are the bride and the groom, and the people are kissing. Thus this image is about the wedding kiss.

The high-level feature extraction module 337 extracts high-level features from the low-level features and EXIF information. The high-level feature extraction module 337 includes a normalization module 337A that generates a normalized time 337B for an image, a location classifier module 337C that identifies a location 337D for an image, and a face detection module 337E that identifies people 337F in an image. Some embodiments also include an object detection module that identifies objects in an image.

The operations performed by the normalization module 337A to determine the time (“when”) an image was captured may be straightforward because image capture time from EXIF information may be available. If the time is not available, the sequence of image files is typically sequential and may be used as a timeline basis. However, images may come from several different capture devices (e.g., cameras), which may have inaccurate and/or inconsistent time settings. Therefore, when the normalization module 337A determines consistent time parameters, it can estimate a set of camera time offsets and then compute a normalized time. For example, in some embodiments images from a same camera are sorted by time, and the low-level features of images from different capture devices are compared to find the most similar pairs. Similar pairs of images are assumed to be about the same event and assumed to have been captured at approximately the same time. Considering a diverse set of matching pairs (e.g., pairs that match but at the same time are dissimilar to other pairs), a potential offset can be calculated. The estimated offset can be determined by using the pairs' potential offsets to vote on a rough camera time offset. Then given this rough offset, the normalization module 337A can eliminate outlier pairs (pairs that do not align) and then estimate the offset with the non-outlier potential offset times. In this way, the normalization module 337A can adjust the time parameters from different cameras to be consistent and can calculate the normalized time for each image. In some embodiments, a user can enter a selection of one or more pairs of images for the estimation of the time offset between two cameras.

Additionally, in some embodiments the location classifier module 337C classifies an image capture location as “indoors” or “outdoors.” In some of these embodiments, a large number of indoor and outdoor images are collected as a training dataset to train an indoor and outdoor image classifier. Firstly, low-level visual features, such as color features for example are used to train a SVM (Support Vector Machine) model to estimate the probability of a location. Then this probability is combined with EXIF information, for example flash settings, time of day, exposure time, ISO, GPS location, and F-stop, to train a naïve Bayesian model to predict the indoor and outdoor locations. In some embodiments, a capture device's color model information could be used as an input to a classifier. Also, in some embodiments, the location classifier module 337C can classify an image capture location as being one of other locations, for example a church, a stadium, an auditorium, a residence, a park, or a school.

The face detection module 337E may use face detection and recognition to extract people information from an image. Since collecting a face training dataset about people appearing in some events, such as wedding ceremonies, may be impractical, face detection might only be done, at least initially. Face detection may allow an estimation of the number of people in an image. Additionally, by clustering all the faces detected using typical face recognition features, the largest face clusters can be determined. For example, events such as traditional weddings typically include two commonly occurring faces: the bride and the groom. For traditional western weddings brides typically wear dresses (often a white dress), which facilitates discriminating the bride from the groom in the two most commonly occurring wedding image faces. In some embodiments the face detection module 337E extracts the number of people in the images and determines whether the bride and/or groom are included in each image.

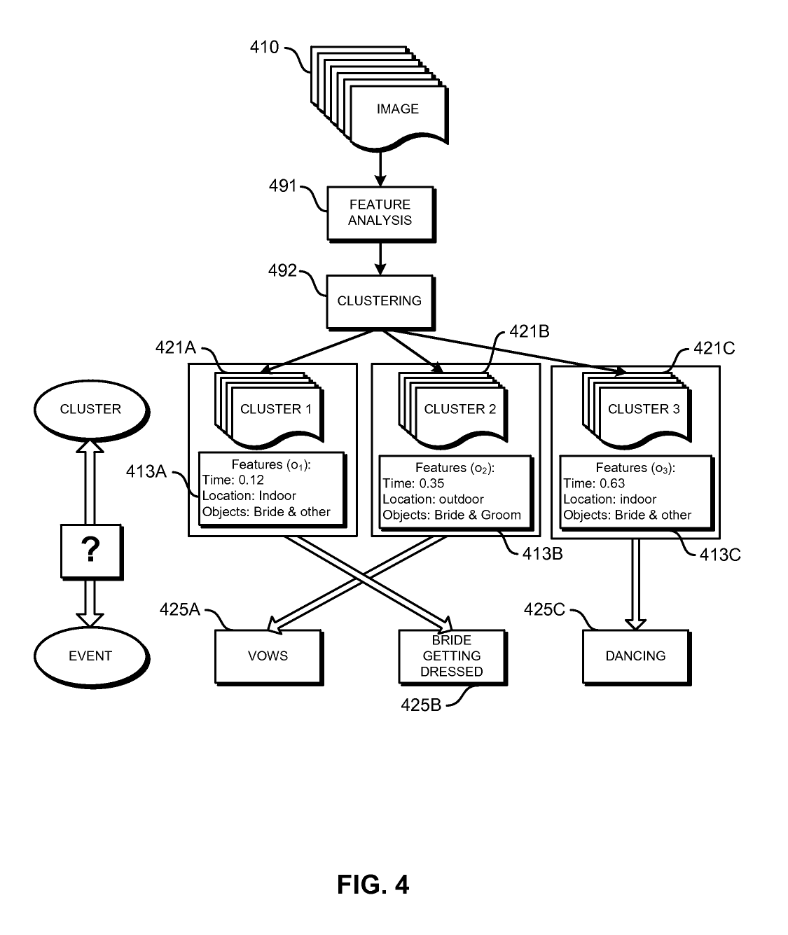

The annotation module 340 uses an event model 323 to add labels 325 to the images. The event model 323 includes a Probabilistic Event Inference Model of individual images, for example a Gaussian Mixture Model (also referred to herein as a “GMM”) 323A, and includes an Event Recognition Model of a temporal sequence of images, for example a Hidden Markov Model (also referred to herein as an “HMM”) 323B. The annotation module 340 uses the event model 323 to associate images/features with sub-events. FIG. 4 illustrates example embodiments of images, features, and events. Images 410 are input to a feature analysis block 491, where features 413 (including high-level features o) are extracted, and then to a clustering block 492, where clusters 421 are generated. The features 413 of a cluster 421 are analyzed to determine the associated event 425, and the features of the images in a cluster may be averaged and applied to all the images in the cluster. For example, the high-level features o₁ of cluster 1 421A include a normalized time (0.12), a location (indoor), and objects/people (bride and other people). The high-level features o₁ are analyzed to determine that the images in cluster 421A depict the bride getting dressed (the sub-event), and a corresponding label 425B is added to the images in cluster 1421A. Also, the high-level features o₂ of cluster 2 421B include a normalized time (0.35), a location (outdoor), and objects/people (bride and groom). Since cluster 2 421B happens at a later time than cluster 1 421A, since the images are outdoors, and since the images include the bride and groom, the sub-event associated with cluster 2 421B is determined to be the vows. Also, a corresponding label 425A is added to the images in cluster 2 421B.

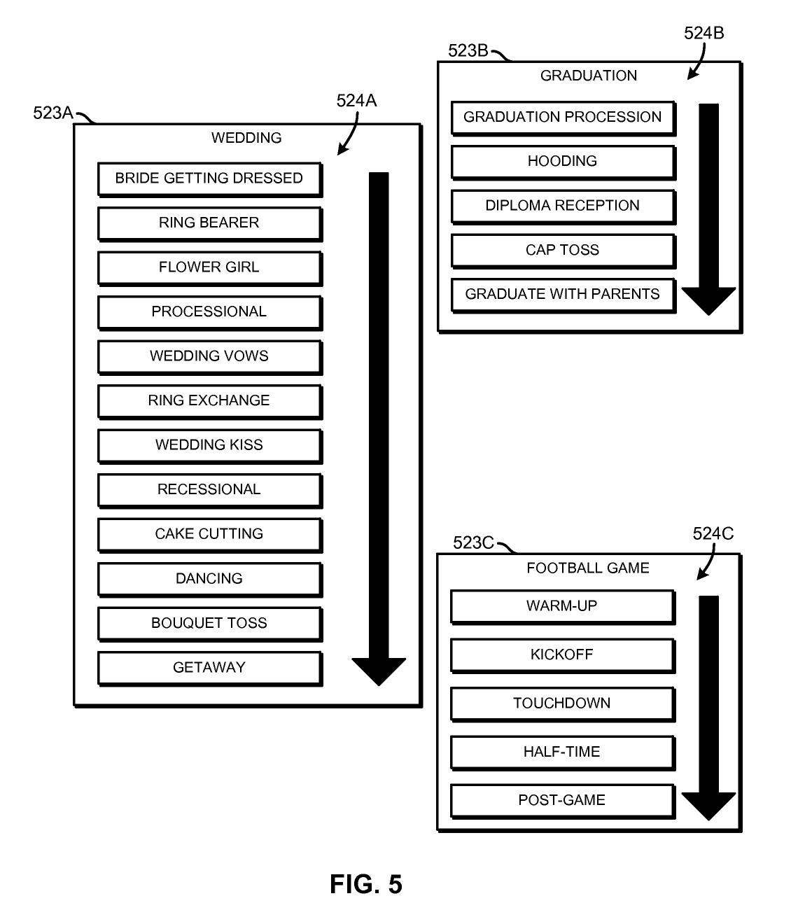

Referring again to FIG. 3, the annotation module 340 determines the labels 325 that are associated with an image based on the features of the image and the event model 323. The event model 323 identifies an order of sub-events, the transition relationships between the sub-events, and/or the features associated with a respective sub-event. FIG. 5 illustrates example embodiments of event models 523A-C. An event model 523 may help resolve the “semantic gap” between low-level features and high-level semantic representations of the images and account for the various meanings that a particular image expresses, depending on the underlying context in which the image was taken. Many images of activities such as wedding ceremonies, sporting events, birthday parties, dramatic productions, and graduation ceremonies, follow some specific routines and structure. For example, a wedding ceremony may vary depending on the country, religion, local customs, etc., but the basic elements of western style weddings are generally the same from one wedding to another. The wedding vows, ring exchange, and wedding kisses are sub-events in a western style wedding. For each type of event, a sub-event taxonomy can be predefined by investigating traditions or daily life experience, or by learning from training dataset.

For example, a model may define sub-events for a western wedding ceremony event, such as the bride getting dressed, the wedding vows, the ring exchange, the wedding kiss, the cake cutting, dancing, etc. Thus, in the example embodiment shown in FIG. 5, the wedding event model 523A includes twelve sub-events 524A: bride getting dressed, ring-bearer, flower girl, processional, wedding vows, ring exchange, wedding kiss, recessional, cake cutting, dancing, bouquet toss, and getaway.

Also, the graduation event model 523B includes five sub-events 524B: graduation processing, hooding, diploma reception, cap toss, and the graduate with parents. Finally, the football game event model 523C includes five sub-events 524C: warm-up, kickoff, touchdown, half-time, and post-game.

The event models 523A-C may be used by the annotation module 340 for the tasks of event identification and image annotation. In some embodiments, a user of the image management system will identify the event model, for example when the user is prompted to input the event based on a predetermined list of events, such as wedding, birthday, sporting event, etc. In some embodiments the system attempts to analyze existing folders or time spans of images on a storage system and applies detectors for certain events. In such embodiments, if there is sufficient evidence for an event based on the content of the images and the corresponding image information (e.g., folder titles, file titles, tags, and other information such as EXIF information) then the annotation module 340 could annotate the images without any user input.

Also, to discover the relationships between features and events and build an event model 323, in some embodiments the annotation module 340 evaluates images in a training dataset in which semantic events for these images were labeled by a user. For example, some wedding image albums from image sharing websites may be downloaded and manually labeled according to the predefined sub-events, such as wedding vow, ring exchange, cake cutting, etc. The labeled images can be used to train a Bayesian classifier for a probabilistic event inference model of individual images (e.g., a GMM) and/or a model for event recognition of a temporal sequence of images (e.g., a HMM). In some embodiments, the training dataset may be generated based on keyword-based image searches using a standard image search engine, such as web-based image search or a custom made search engine. The search results may be generated based on image captions, surrounding web-page text, visual features, image filenames, page names, etc. The results corresponding to the query word(s) results may be validated before being added to the training dataset.

The probabilistic event inference model of individual images, which is implemented in the event model 323 (e.g., the GMM module 323A), models the relationship between the extracted low-level visual features and the sub-events. In some embodiments, the probabilistic event inference model is a Bayesian classifier,

$$p ( e \vert x ) = \frac{p ( e ) \cdot p ( x \vert e )}{p ( x )} ,$$

where x is a D-dimensional continuous-valued data vector (e.g., the low-level features for each image), and e denotes an event. In some embodiments, the likelihood p (x|e) is a Gaussian Mixture Model. The GMM is a parametric probability density function represented as a weighted sum of Gaussian component densities, and a GMM of M component Gaussian densities is given by

$$p ( x \vert λ ) = {\sum }_{i = 1}^{M} {w}_{i} g ( x \vert {μ}_{i} , {Σ}_{i} ) , \qquad ( 1 )$$

where x is a D-dimensional continuous-valued data vector (e.g., the low-level features for each image); wᵢ, i=1, . . . , M are the mixture weights; and g (x|μᵢ, Σᵢ), i=1, . . . , M are the component Gaussian densities. Each component density is a D-variant Gaussian function

$$g ( x \vert {μ}_{i} , {Σ}_{i} ) = \frac{1}{{( 2 π )}^{\frac{D}{2}} {\vert {Σ}_{i} \vert}^{\frac{1}{2}}} exp \{ - \frac{1}{2} {( x - {μ}_{i} )}^{T} {Σ}_{i}^{- 1} ( x - {μ}_{i} ) \} , \qquad ( 2 )$$

with mean vector μᵢ and covariance matrix Σᵢ. The mixture weights satisfy the constraint that

$${\sum }_{i = 1}^{M} {w}_{i} = 1.$$

The complete GMM is parameterized by the mean vectors μᵢ, covariance matrices Σᵢ, and mixture weights wᵢ, from all component densities. These parameters are collectively represented by the notation

λ={wᵢ,μᵢΣᵢ}, i=1, . . . , M. (3)

To recognize a sub-event, the goal is to discover the mixture weights wᵢ, mean vector μᵢ, and covariance matrix Σᵢ for the sub-event. To find the appropriate values for λ, low-level visual features extracted from images (e.g., training images) that are associated with a particular sub-event are analyzed. Then, given a new image and the corresponding low-level visual feature vector, the probability that this image conveys the particular event is calculated according to equation (1).

In some embodiments, the iterative Expectation-Maximization (also referred to herein as “EM”) algorithm is used to estimate the GMM parameters λ. Since the low-level visual feature vector may be very high dimensional, Principle Component Analysis may be used to reduce the number of dimensions, and then the EM algorithm may be applied to compute the GMM parameters 2. Then equations (1) and (2) may be used for probability prediction.

The GMM module 323A is configured to perform GMM analysis on low-level image features and may also be configured to train a GMM for each sub-event. For example, in the GMM module 323A, a GMM for each type of event can be trained, and then for a new image phᵢ and its low-level visual features, the GMM module 323A computes Pᵢⱼ^{GMM} (eᵢ|phⱼ) as the probability that image phᵢ depicts event eᵢ by Bayes' rule. Also, some embodiments may use probability density functions other than a GMM.

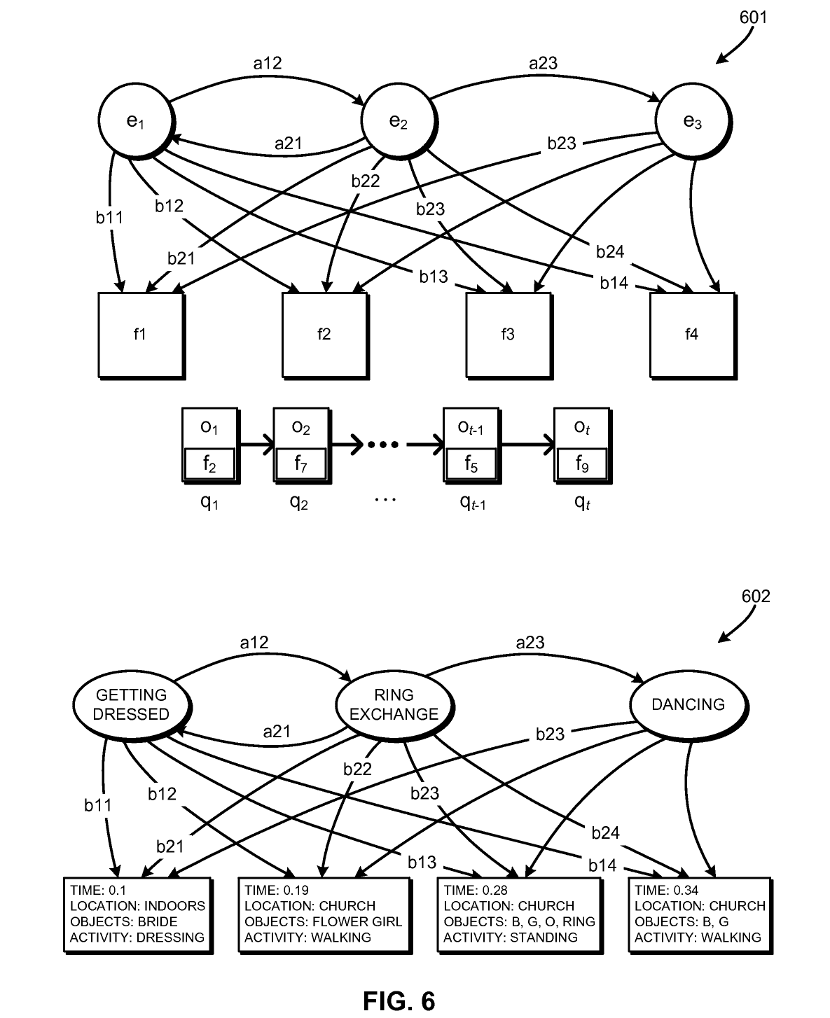

In addition to a probabilistic inference function, the annotation module includes a HMM module 323B, which implements an Event Recognition Model of a temporal sequence of images, for example a HMM. The normalized time 337B, the location 337D, the people 337F, and/or the output of the GMM module 323A can be input to the HMM module 323B. A Hidden Markov Model is a statistical Markov model in which the system being modeled is assumed to be a Markov process with unobserved (hidden) states. FIG. 6 shows example embodiments of Hidden Markov Models. A first HMM 601 shows that a HMM contains an unobserved states collection E={e₁, e₂, . . . , e_{N}}, with the number of states N, and with qₜ denoting the current unobserved state at time t. The observed state value universe is F={f₁, f₂, . . . , f_{M}}, with a number of state values M, and with oₜ denoting the observed state value at time t. The state transition probability for transitioning from state i to state j is denoted as aᵢⱼ and the probability of state j having observed state value fₖ is denoted as bⱼ(k) (which may be labeled “bⱼₖ”).

A second HMM 602 shows that the unobserved states E may refer to sub-events, for example the bride getting dressed, the ring exchange, etc., in wedding ceremony events; the observed state values F may refer to the high-level features (e.g., time, location, people) that were extracted from the images and their associated data; the state transition probabilities aᵢⱼ are the probabilities of transitioning sequentially from one sub-event to another sub-event; and the observed state value probabilities bⱼ(k) are the probabilities of observing particular feature values (index k) given a sub-event (index j).

The HMM module 323B is configured to learn the HMM parameters. The HMM parameters contain three parameters {π, aᵢⱼ, bⱼ(k)}, where n denotes the initial state distribution, and with aᵢⱼ and bⱼ(k). The three parameters can be learned from a training dataset or from previous experiences. For example, π can be learned from the statistical analysis of initial state values in training dataset, and aᵢⱼ and bⱼ(k) can be learned using Bayesian techniques.

The state transition probability is given by aᵢⱼ=P{qₜ₊₁=eⱼ|qₜ=eⱼ}, which is the probability of a transition from state eᵢ to state eⱼ from time or sample t to t+1. The output probability is denoted by bⱼ(k)=P(oₜ=fₖ|qₜ=eⱼ), the probability that state eⱼ has the observation value fₖ. Using the wedding ceremony images as an example, π denotes the statistical distribution of the first event extracted from the images, and aᵢⱼ and bⱼ(k) can be learned from the labeled dataset.

Also, the event recognition problem can be transformed into a decoding problem: Given an observation sequence O={o₁, o₂, . . . , o_{T}} and a set of HMM parameters {π, aᵢⱼ, bⱼ(k)}, try to get the optimal corresponding unobserved state sequence Q={q₁, q₂, . . . , q_{T}}. In the example of wedding ceremonies, given a sequence of features (including time, location, and people information), the goal is to discover the optimal corresponding event sequence.

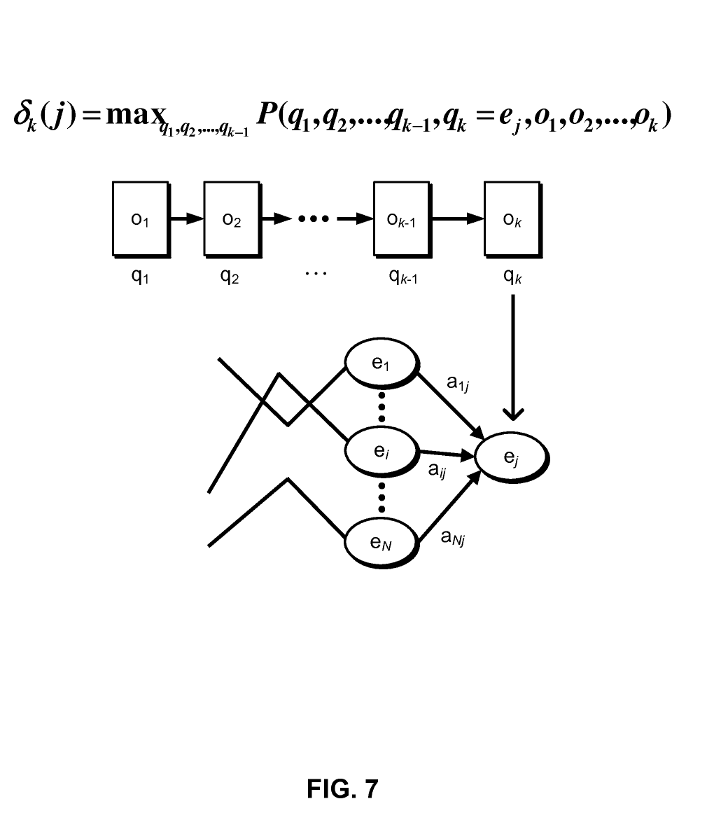

Furthermore, a Viterbi algorithm may be combined with the output of the GMM module 323A. A Viterbi algorithm describes how to find the most likely sequence of hidden states. FIG. 7 shows an example embodiment of a Viterbi algorithm. A variable δₖ(j) is defined as the maximum probability of producing the observed feature value sequence o₁, o₂, . . . , oₖ when moving along any unobserved state sequence q₁, q₂, . . . , qₖ₋₁ and getting to qₖ=eⱼ:

$${δ}_{k} ( j ) = {max}_{{q}_{1} , {q}_{2} , … , {q}_{k - 1}} P ( {q}_{1} , {q}_{2} , … , {q}_{k - 1} , {q}_{k} = {e}_{j} , {o}_{1} , {o}_{2} , … , {o}_{k} ) . \qquad ( 4 )$$

Therefore, to determine the best state-path to qₖ, each state-path from q₁ to qₖ₋₁ is determined. Also, if the best state-path ending in qₖ=eⱼ goes through qₖ₋₁=eᵢ, then it may coincide with the best state-path ending in qₖ₋₁=eᵢ. A computing device that implements the Viterbi algorithm computes and records each δₖ(j), 1≦k≦K, 1≦j≦N, chooses the maximum δₖ (i) for each value of k, and may back-track the best path.

However, since the sequence in the Markov chain may be very long and since inaccuracies may exist in the feature states, the errors in the previous event states may impact the following states and lead to poor performance. To solve this problem, some embodiments combine the GMM event prediction results Pᵢⱼ^{GMM}(eᵢ|phⱼ), which are based on low-level features, with HMM techniques to compute the best event sequence. These embodiments perform the following operations:

(a) Initialization: Calculate the sub-event score δₖ(j) for each sub-event (1≦j≦N) for the first image in the sequence of images (k=1, where k is the index of an image in the sequence of images, the image's low-level features phₖ, and the image's high-level features oₖ) according to

δₖ(j)=w₁πⱼbⱼ(oₖ)+w₂Pⱼₖ^{GMM}(eⱼ|phₖ)bⱼ(oₖ), (5)

where w₁, w₂ are weights for the two parts and w₁+w₂=1. Therefore, for the first image in a sequence (k=1), a sub-event score δ₁(j) is determined for all N sub-events in the event model.

(b) Forward Recursion: Calculate the sub-event score δₖ(j) for each sub-event (1≦j≦N) for any subsequent images (2≦k≦K) in the sequence of images according to

$$\begin{matrix}\begin{matrix}{δ}_{k} ( j ) = {max}_{{q}_{1} , {q}_{2} , … , {q}_{k - 1}} P ( {q}_{1} , {q}_{2} , … , {q}_{k - 1} , {q}_{k} = {e}_{j} , {o}_{1} , {o}_{2} , … , {o}_{k} ) \\ = {max}_{i} [ \begin{matrix}{w}_{1} {a}_{ij} {b}_{j} ( {o}_{k} ) {max}_{{q}_{1} , {q}_{2} , … , {q}_{k - 2}} \\ P ( {q}_{1} , {q}_{2} , … , {q}_{k - 1} = {e}_{i} , {o}_{1} , {o}_{2} , … , {o}_{k - 1} ) + \\ {w}_{2} {P}_{jk}^{GMM} ( {e}_{j} , p {h}_{k} ) {b}_{j} ( {o}_{k} )\end{matrix} ] \\ = {max}_{i} [ {w}_{1} {a}_{ij} {b}_{j} ( {o}_{k} ) {δ}_{k - 1} ( i ) + {w}_{2} {P}_{jk}^{GMM} ( {e}_{j} , p {h}_{k} ) {b}_{j} ( {o}_{k} ) ] ,\end{matrix} & ( 6 ) \\ 1 \leq i \leq N . & \end{matrix}$$

Therefore, at the second image in a sequence (k=2), assuming that the event model includes 3 sub-events (N=3), a sub-event score δ₂(j) is calculated for all 3 sub-events. Furthermore, for all 3 of the sub-event scores δ₂(j), 3 sub-event path scores (w₁aᵢⱼbⱼ(oₖ)δₖ₋₁(i)) are calculated, for a total of 9 sub-event path scores. Note that each sub-event score δ₂(j) is also based on a GMM-based score (w₂Pⱼₖ^{GMM}(eⱼ, phₖ)bⱼ(oₖ)), and the maximum sub-event path score/GMM-based score combination is selected for each sub-event score δ₂ (j).

(c) Choose the sub-event j that is associated with the highest sub-event score δₖ (j) for each image k in the sequences of images (for all k≦K):

maxⱼ[δₖ(j)], 1≦j≦N. (7)

(d) Backtrack the best path.

Therefore, the sub-event (state) probability relies on the previous sub-event probability as well as the GMM prediction results from the low-level image features. In this way, both the low-level visual features and the high-level features are leveraged to compute the best sub-event sequence. Once an error occurs in one state, the GMM results can re-adjust the results of the following state. Therefore, given a sequence of images and corresponding features that are ordered by image capture time, the method may determine the most likely sub-event sequence that is described by these images.

Referring again to FIG. 3, the annotation module 340 generates event/sub-event labels 325 based on the high-level features (e.g., normalized time 337B, location 337D, and people 337F) and low-level features (e.g., GMM results) in an image. The event/sub-event labels 325 can then be applied to the corresponding image(s). Therefore, the annotation module 340 identifies sub-events in images and generates corresponding labels. Consequently, given a collection of images about a structured event, the image management system (e.g., the annotation module) is able to automatically annotate the images with labels that describe the event/sub-events. Also, referring to FIG. 2, an indexing module 260 indexes the images based on their respective labels (which may significantly facilitate future text queries and searches, as well as aid in combining image collections from multiple cameras), and a query module 270 receives search queries and searches the indexed images to determine the results to the query.

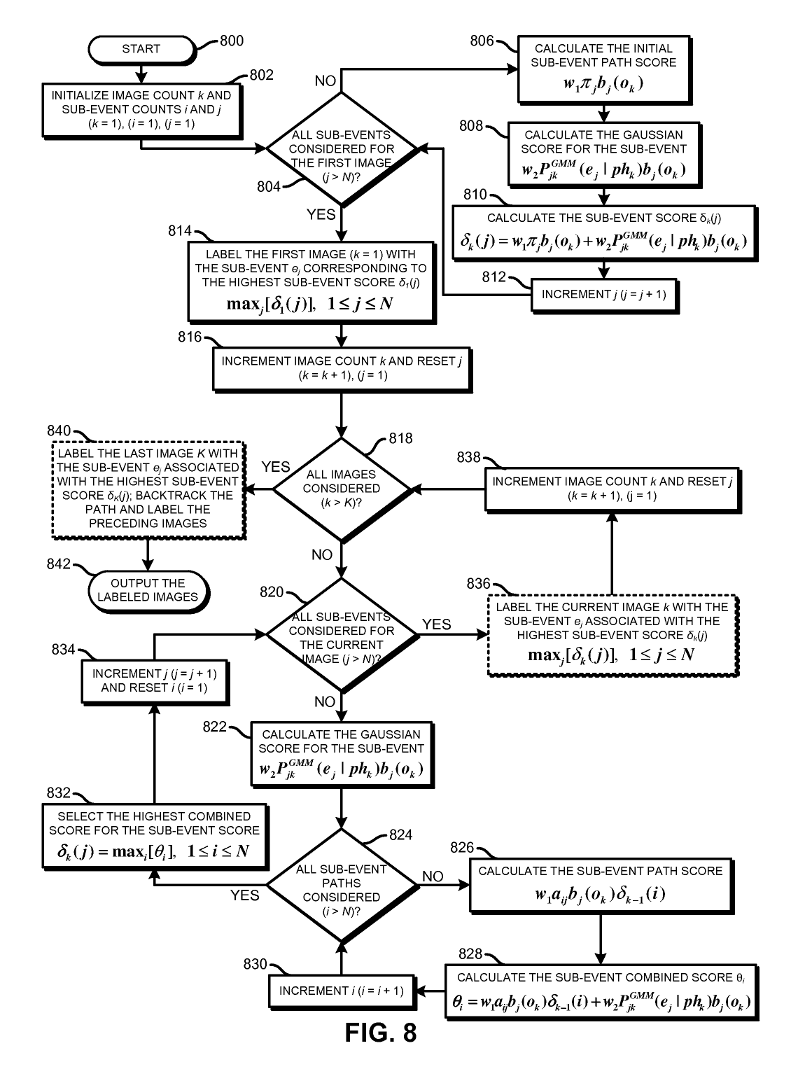

FIG. 8 illustrates an example embodiment of a method for labeling images. Also, other embodiments of this method and the other methods described herein may omit blocks, add blocks, change the order of the blocks, combine blocks, and/or divide blocks into multiple blocks. Additionally, the methods described herein may be implemented by the systems and devices described herein.

The flow starts in block 800 and then proceeds to block 802, where image count k (the count in a sequence of K images) and sub-event counts i and j are initialized (k=1, i=1, j=1). Next, in block 804, it is determined (e.g., by a computing device) if all sub-events for a first image (k=1) have been considered (j>N, where N is the total number of sub-events). If not, the flow proceeds to block 806, where an initial sub-event path score is calculated, for example according to w₁πⱼbⱼ(oₖ). Next, in block 808, a GMM-based score is calculated for the sub-event, for example according to w₂Pⱼₖ^{GMM}(eⱼ|phₖ)bⱼ(oₖ). Following block 808, in block 810 the sub-event score δₖ(j) is calculated by summing the two scores from blocks 806 and 808. The flow then proceeds to block 812, where j is incremented (j=j+1), and then the flow returns to block 804.

If in block 804 it is determined that all sub-events have been considered for the first image, then the flow proceeds to block 814, where the first image is labeled with the sub-event eⱼ associated with the highest sub-event score δ₁(j). Next, in block 816, the image count k is incremented and the sub-event count j is reset to 1. The flow then proceeds to block 818, where it is determined if all K images in the sequence have been considered. If not, the flow proceeds to block 820, where it is determined if all sub-events have been considered for the current image. If all sub-events have not been considered, then the flow proceeds to block 822, where the GMM-based score of image k is calculated for the current sub-event j, for example according to w₂Pⱼₖ^{GMM} (eⱼ, phₖ)bⱼ(oₖ). Next, in block 824, it is determined if all sub-event paths to the current sub-event j have been considered, where i is the count of the currently considered previous sub-event. If all paths have not been considered, then the flow proceeds to block 826, where the sub-event path score of the pair of the current sub-event j and the previous sub-event i is calculated, for example according to w₁aᵢⱼbⱼ(oₖ)δₖ₋₁(i). Afterwards, in block 828 the sub-event combined score θᵢ is calculated, for example according to w₁aᵢⱼbⱼ(oₖ)δₖ₋₁(i)+w₂Pⱼₖ^{GMM} (eⱼ, phₖ)bⱼ(oₖ), and may be stored (e.g., on a computer-readable medium) with the previous sub-event(s) in the path. Thus, when all the images have been considered, for each image the method may generate a record of all the respective sub-event scores and their previous sub-event(s), thereby defining a path to all the sub-event scores. Next, in block 830 the count of the currently considered previous sub-event i is incremented.

The flow then returns to block 824. If in block 824 it is determined that all sub-event paths have been considered, then the flow proceeds to block 832. In block 832, the highest combined score θᵢ is selected for the sub-event score for the current sub-event j, and the previous sub-event in the path to the highest combined score θᵢ is stored. The flow then proceeds to block 834, where the current sub-event count j is incremented and the count of the currently considered previous sub-event i is reset to 1. The flow then returns to block 820.

If in block 820 it is determined that all sub-events have been considered for the current image k, then in some embodiments the flow proceeds to block 836, where the current image k is labeled with the label(s) that correspond to the sub-event that is associated with the highest sub-event score δₖ of all N sub-events. Some embodiments omit block 836 and proceed directly to block 838. Next, in block 838, the image count k is incremented, and the current sub-event count j is reset to 1. The flow then returns to block 818, where it is determined if all the images have been considered (k>K). If yes, then in some embodiments the flow then proceeds to block 840. In block 840, the last image is labeled with the sub-event that is associated with the highest sub-event score, and the preceding images are labeled by backtracking the path to the last image's associated sub-event and labeling the preceding images according to the path. Finally, the flow proceeds to block 842, where the labeled images are output and the flow ends.

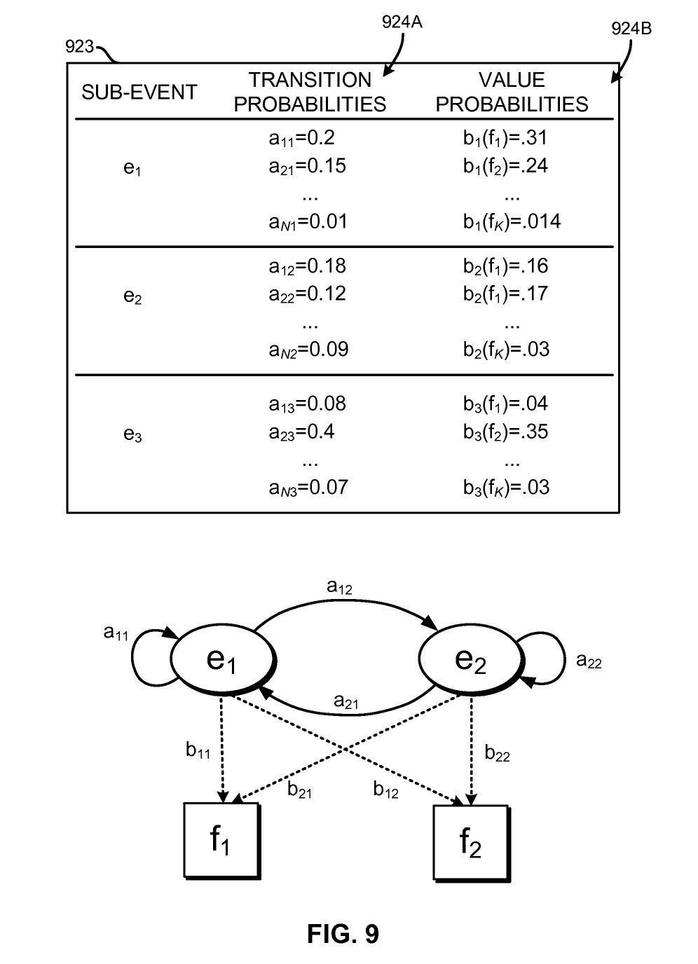

FIG. 9 shows an example embodiment of transition probabilities 924A and observed state value probabilities 924B for an event model 923. For a first sub-event e₁, the transition probabilities 924A include the transition probabilities for the transitions from all N sub-events to the first sub-event e₁, including the probability of a transition from e₁ to itself. Also, the value probabilities 924B includes the probabilities of the first sub-event e₁ having the observed features values for all K sets of feature values. For example, the set of features f₁ may include the following feature values: time=0.17, location=church, objects=girl and flowers, and activity=walking Note that the columns of the table are independent (the transition a₁₁ is independent of the observed state value b₁(f₁) and N may not equal K).

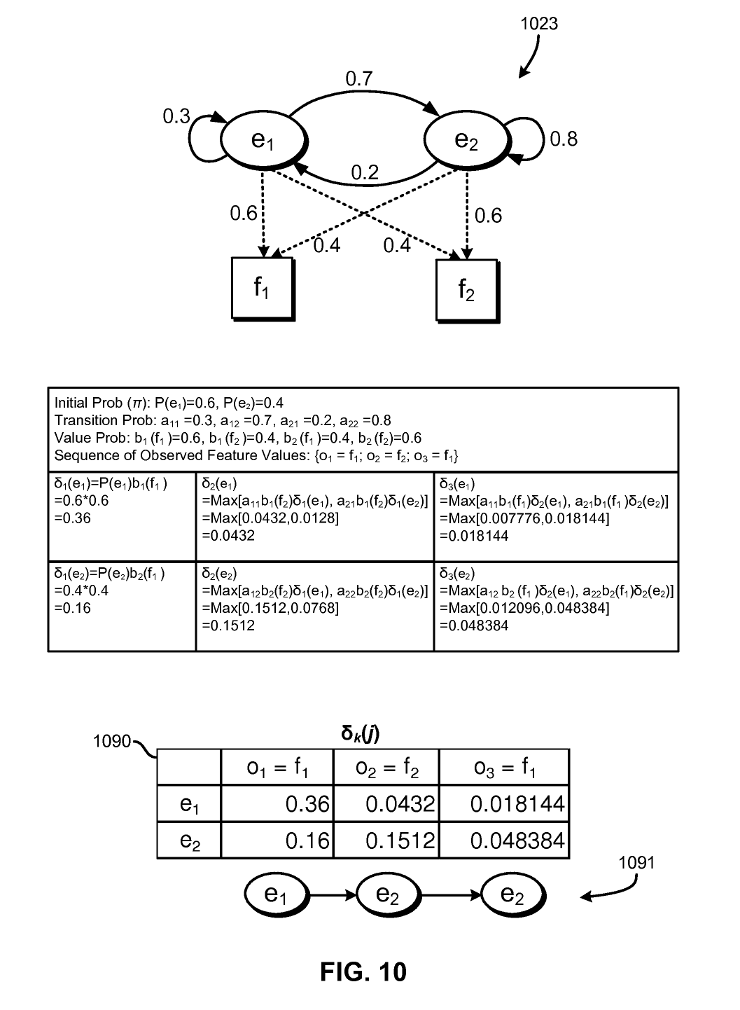

FIG. 10 shows an example of sub-event scores δₖ(j) for a sequence of observed state values based on an event model 1023 (shown in graph form). The sequence of observed feature values is o₁=f₁, o₂=f₂, and o₃=f₁. The initial probability π includes P(e₁)=0.6 and P(e₂)=0.4. The transition probabilities include a₁₁=0.3, a₁₂=0.7, a₂₁=0.2, and a₂₂=0.8. The observed state value probabilities include b₁(f₁)=0.6, b₁(f₂)=0.4, b₂(f₁)=0.4, and b₂(f₂)=0.6.

The sub-event scores δ₁(j) for the first observed state values o₁=f₁ are calculated: δ₁(e₁)=0.36, and δ₁(e₂)=0.16. Next, the sub-event scores δ₂(j) for the second observed state values o₂=f₂ are calculated: δ₂(e₁)=0.0432, and δ₂(e₂)=0.1512. Note that the sub-event scores δ₂(j) for the second observed state values depend on the sub-event scores δ₁(j) for the first observed state values, and for each sub-event eⱼ there is a number of sub-event scores equal to the number of possible preceding sub-events (i.e., the number of paths to the second event from the first event), which is two in this example. For example, for the second observed state values o₂=f₂ and the first sub-event e₁, there are two possible sub-event scores: 0.0432 for the path through the first sub-event e₁ and 0.0128 for the path through the second sub-event e₂. Thus, since respective multiple sub-event scores are possible for each sub-event, the respective highest sub-event score may be selected as a sub-event's score. Finally, the sub-event scores δ₃(j) for the third observed state values o₃=f₁ are calculated: δ₃(e₁)=0.018144, and δ₃(e₂)=0.048384. Also, the corresponding previous sub-event (state) is recorded for each sub-event score. For example, to achieve δ₂(e₁)=0.0432, the previous sub-event (the first state) should be e₁, so e₁ is recorded as the previous state for δ₂(e₁)=0.0432. Likewise, e₁ is the previous state for δ₂(e₂)=0.1512, e₂ is the previous state for δ₃(e₁)=0.018144, and e₂ is the previous state for δ₃(e₂)=0.048384.

For each observed feature value oₖ, the highest sub-event score δₖ(j) for each sub-event is shown in a table 1090, and for each observed feature value oₖ, the sub-event that corresponds to the highest sub-event score may be selected as the associated event. Therefore, the sequence of sub-events 1091 is determined to be e₁, e₂, e₂. Also, the sub-event may be selected by backtracking the path to the last image. For example, for o₃=f₁, the sub-event associated with the highest score, δ₃(e₂)=0.048384, is selected, and thus e₂ is selected as the third sub-event (state); because e₂ is the previous sub-event (state) for δ₃(e₂)=0.048384, e₂ is selected as the second sub-event (state); and because e₁ is the previous sub-event (state) for δ₂(e₂)=0.1512, e₁ is selected as the first sub-event (state). So the final sequence is eᵢ, e₂, e₂.

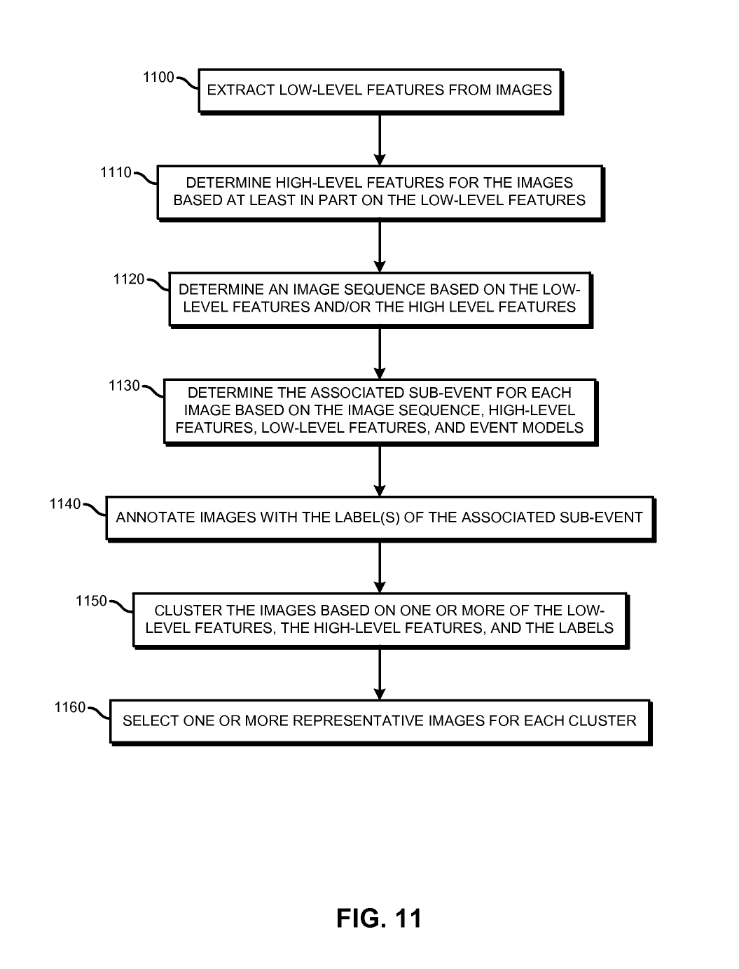

FIG. 11 shows an example embodiment of a method for labeling images. The method starts in block 1100, where low-level features are extracted from one or more images. Next, in block 1110, high-level features are determined for the one or more images based at least in part on the low-level features. The flow then proceeds to block 1120, where an image sequence is determined based on one or more of the low-level features and the high-level features. In block 1130, the respective associated sub-event for each image is determined based on one or more of the image sequence, the high-level features, the low-level features, and one or more event models. Following, in block 1140, the images are annotated with the label(s) of their respective associated sub-event. In some embodiments, blocks 1130 and 1140 are performed as described in FIG. 8. Next, in block 1150, the images are clustered into clusters based on one or more of the low-level features, the high-level features, and the labels. Finally, in block 1160, one or more representative images are selected for each cluster.

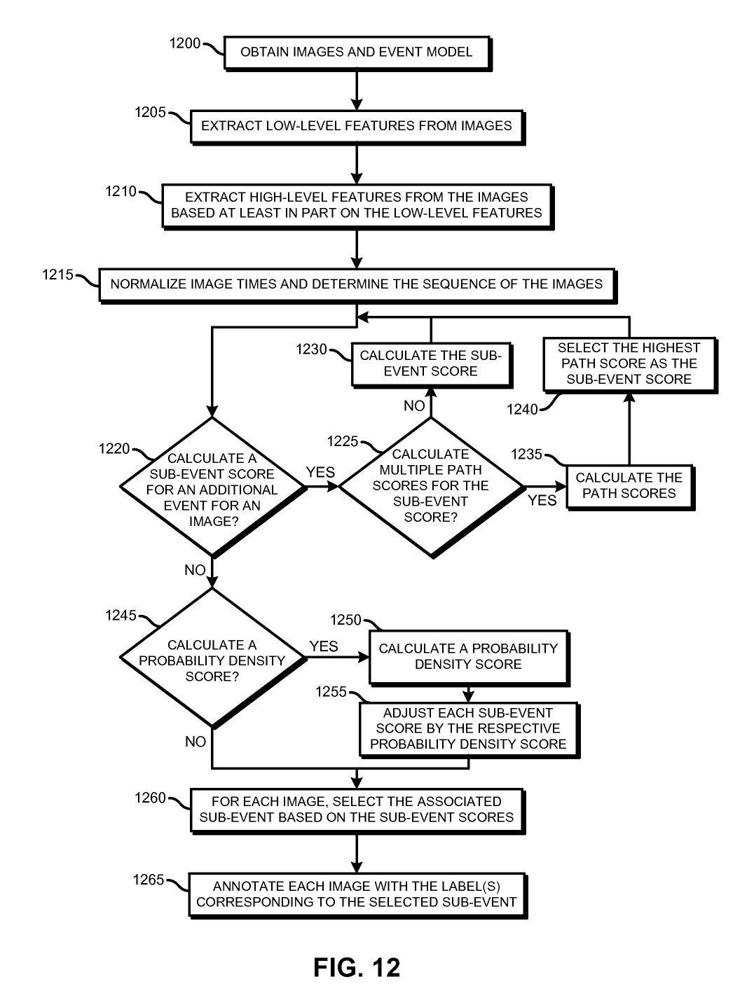

FIG. 12 shows an example embodiment of a method for labeling images. The flow starts in block 1200, where images and an event model are obtained (e.g., retrieved from one or more computer-readable media). Next, in block 1205, low-level features are extracted from the images, and in block 1210 high-level features are extracted from the images based at least in part on the low-level features. The flow then proceeds to block 1215, where the times of the images are normalized and the sequence of the images is determined, for example where different cameras captured some of the images.

Next, in block 1220, it is determined if a sub-event score is to be calculated for an additional event for an image. Note that the first time the flow reaches block 1220, the result of the determination will be yes. If yes (e.g., if another image is to be evaluated, if a sub-event needs to be evaluated for an image that has already been evaluated for another sub-event), then the flow proceeds to block 1225, where it is determined if multiple path scores are to be calculated for the sub-event score. If no, for example when calculating a sub-event score does not include calculating multiple path scores for the sub-event, the flow proceeds to block 1230, where the sub-event score for the sub-event/image pair is calculated, and then the flow returns to block 1220. However, if in block 1225 it is determined that multiple path scores are to be calculated for the current sub-event score, then the flow proceeds to block 1235, where the path scores are calculated for the sub-event. Next, in block 1240, the highest path score is selected as the sub-event score, and then the flow returns to block 1220. Blocks 1220-1240 may be repeated until every image has had at least one sub-event score calculated for a sub-event (one-to-one correspondence between images and sub-event scores), and in some embodiments blocks 1220-1240 are repeated until every image has had respective sub-event scores calculated for multiple events (one-to-many correspondence between images and sub-event scores).

If in block 1220 it is determined that another sub-event score is not to be calculated, then the flow proceeds to block 1245, where it determined if a probability density score (e.g., GMM-based score) is to be calculated for each image (which may include calculating a probability density score for each sub-event score). If no, then the flow proceeds to block 1260 (discussed below). If yes, then the flow proceeds to block 1250, where a probability density score is calculated, for example for each image, for each sub-event score, etc. Next, in block 1255, each sub-event score is adjusted by the respective probability density score (e.g., the probability density score of the corresponding image, the probability density score of the sub-event). The flow then proceeds to block 1260, where for each image, the associated sub-event is selected based on the sub-event scores. For example, the associated sub-event for a current image may be selected by following the path from the sub-event associated with the last image to the current image, or the sub-event that has the highest sub-event score for the current image may be selected. Finally, in block 1265, each image is annotated with the label or labels that correspond to the selected sub-event.

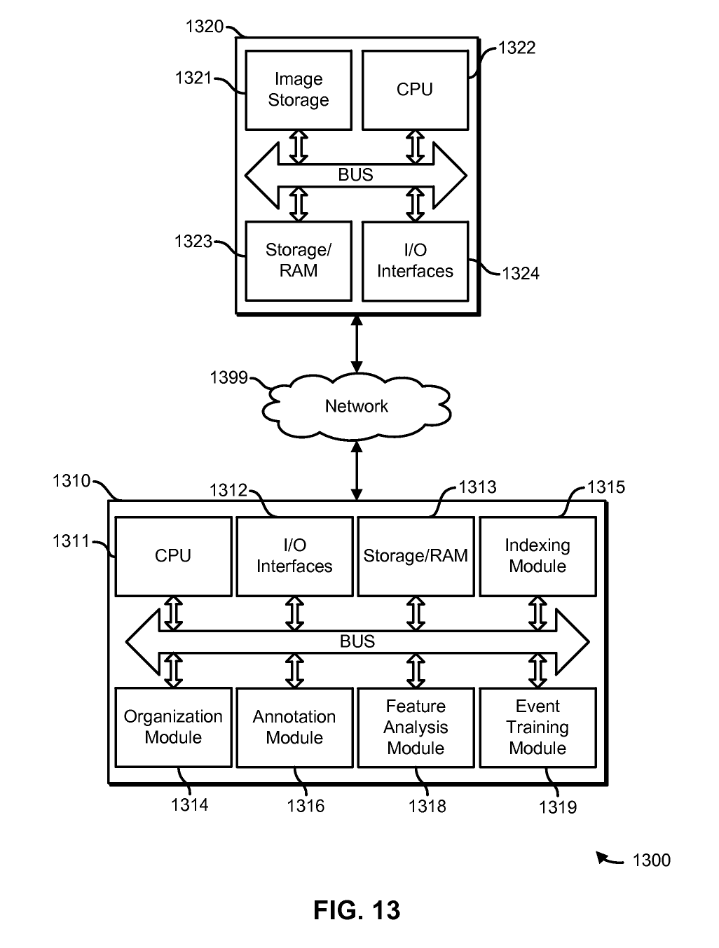

FIG. 13 is a block diagram that illustrates an example embodiment of an image management 1300. The system includes an organization device 1310 and an image storage device 1320, each of which includes one or more computing devices (e.g., a desktop computer, a server, a PDA, a laptop, a tablet, a smart phone). The organization device 1310 includes one or more processors (CPU) 1311, I/O interfaces 1312, and storage/RAM 1313. The CPU 1311 includes one or more central processing units (e.g., microprocessors) and is configured to read and perform computer-executable instructions, such as instructions stored in the modules. The computer-executable instructions may include those for the performance of the methods described herein. The I/O interfaces 1312 provide communication interfaces to input and output devices, which may include a keyboard, a display, a mouse, a printing device, a touch screen, a light pen, an optical storage device, a scanner, a microphone, a camera, a drive, and a network (either wired or wireless).

Storage/RAM 1313 includes one or more computer readable and/or writable media, and may include, for example, a magnetic disk (e.g., a floppy disk, a hard disk), an optical disc (e.g., a CD, a DVD, a Blu-ray disc), a magneto-optical disk, a magnetic tape, semiconductor memory (e.g., a non-volatile memory card, flash memory, a solid state drive, SRAM, DRAM), an EPROM, an EEPROM, etc. Storage/RAM 1313 is configured to store computer-readable data and/or computer-executable instructions. The components of the organization device 1310 communicate via a bus.

The organization device 1310 also includes an organization module 1314, an annotation module 1316, a feature analysis module 1318, an indexing module 1315, and an event training module 1319, each of which is stored on a computer-readable medium. In some embodiments, the organization device 1310 includes additional or fewer modules, the modules are combined into fewer modules, or the modules are divided into more modules. The organization module 1314 includes computer-executable instructions that may be executed to cause the organization device 1310 to generate clusters of images and select one or more representative images for each cluster. The annotation module 1316 includes computer-executable instructions that may be executed to cause the organization device 1310 to generate respective sub-event labels for images (e.g., as described in FIG. 8, FIG. 11, FIG. 12) based on image features and an event model. Also, the feature analysis module 1318 includes computer-executable instructions that may be executed to cause the organization device 1310 to extract low-level features from images and to extract high-level features from images. The indexing module 1315 includes computer-executable instructions that may be executed to cause the organization device 1310 to index images and process queries, and the event training module 1319 includes computer-executable instructions that may be executed to cause the organization device 1310 to generate one or more event models, for example by analyzing a training dataset.

Therefore, the organization module 1314, the annotation module 1316, the feature analysis module 1318, the indexing module 1315, and/or the event training module 1319 may be executed by the organization device 1310 to cause the organization device 1310 to implement the methods described herein.

The image storage device 1320 includes a CPU 1322, storage/RAM 1323, and I/O interfaces 1324. The image storage device 1320 also includes image storage 1321. Image storage 1321 includes one or more computer-readable media that store features, images, and/or labels thereon. The members of the image storage device 1320 communicate via a bus. The organization device 1310 may retrieve images from the image storage 1321 in the image storage device 1320 via a network 1399.

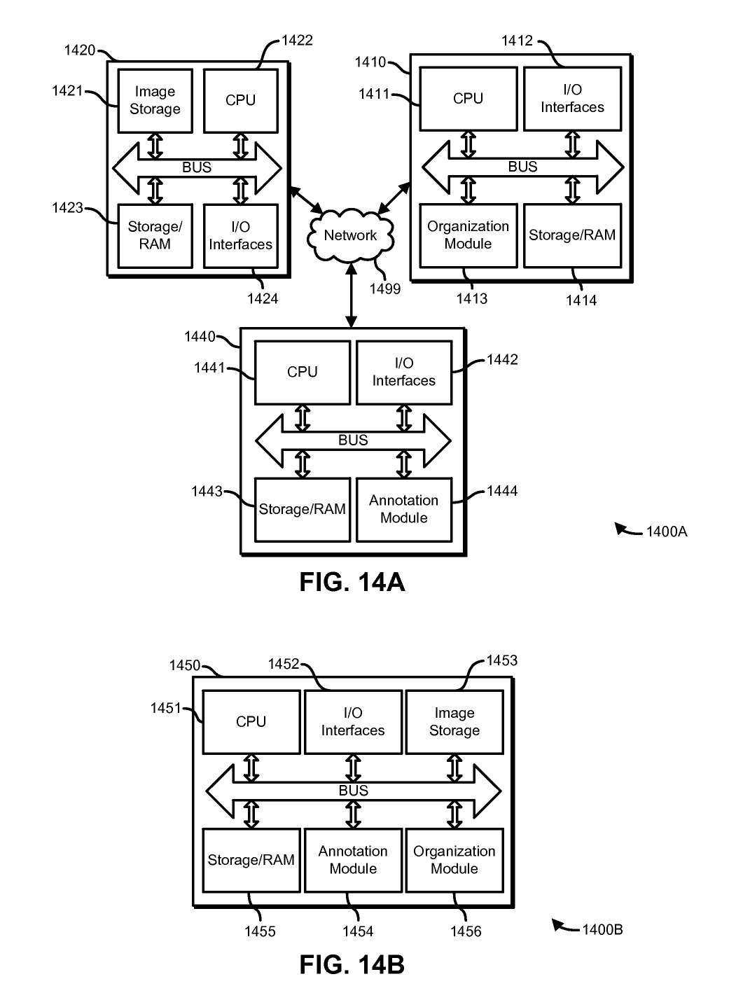

FIG. 14A is a block diagram that illustrates an example embodiment of an image management system 1400A. The system 1400A includes an organization device 1410, an image storage device 1420, and an annotation device 1440. The organization device 1410 includes a CPU 1411, I/O interfaces 1412, an organization module 1413, and storage/RAM 1414. When executed, the organization module 1413 extracts low-level features from images, extracts high-level features from images (e.g., based on the low level features), generates clusters of images, and selects representative images. Thus, the organization module 1413 combines the organization module 1314 and the feature analysis module 1318 illustrated in FIG. 13. The image storage device 1420 includes a CPU 1422, I/O interfaces 1424, image storage 1421, and storage/RAM 1423. The annotation device 1440 includes a CPU 1441, I/O interfaces 1442, storage/RAM 1443, and an annotation module 1444. The annotation module 1444 generates event models and generates sub-event labels for images, and thus combines the annotation module 1316 and the event training module 1319 shown in FIG. 13. The components of each of the devices communicate via a respective bus. The annotation device 1440, the organization device 1410, and the image storage device 1420 communicate via a network 1499 to collectively access the images in the image storage 1421, organize the images, generate sub-event labels for the images, generate event models, and select representative images. Thus, in this embodiment, different devices may store the images, organize the images, and annotate the images.

FIG. 14B is a block diagram that illustrates an example embodiment of an image management system 1400B. The system includes an organization device 1450 that includes a CPU 1451, I/O interfaces 1452, image storage 1453, an annotation module 1454, storage/RAM 1455, and an organization module 1456. The members of the organization device 1450 communicate via a bus. Therefore, in the embodiment shown in FIG. 14B, one computing device stores the images, extract features from the images, clusters the images, trains event models, annotates the images with sub-event labels, etc. However, other embodiments may organize the components differently than the example embodiments shown in FIG. 13, FIG. 14A, and FIG. 14B.

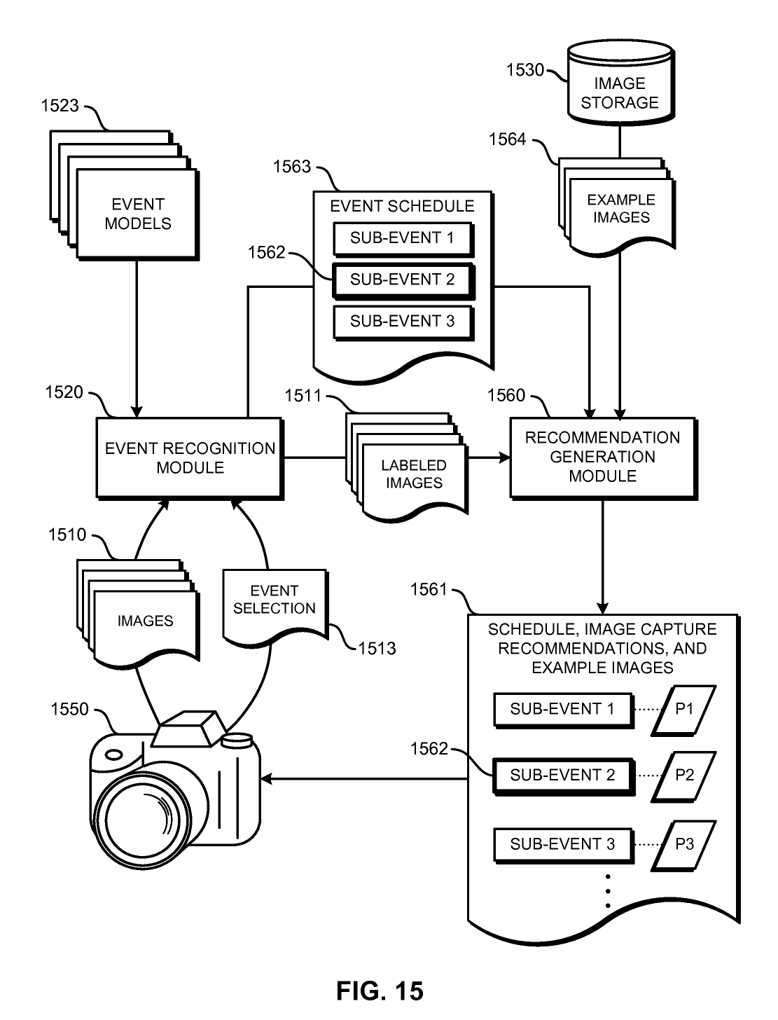

Additionally, at least some of the capabilities of the previously described systems, devices, and methods can be used to generate photography recommendations. FIG. 15 illustrates an example embodiment of the flow of operations in a photography recommendation system (also referred to herein as a “recommendation system”). The photography recommendation system provides real-time photography recommendations to help photographers capture important events, such as wedding ceremonies, sporting events, graduation ceremonies, etc. Taking a professionally appearing image is a complicated process that requires careful consideration of many photography elements, such as focus, view point, angle, pose, lighting, and exposure, as well as interactions among the elements. The recent growth of online media, including millions of shared professional quality images, allows the photography recommendation system to mine the underlying photography skills and knowledge in the available images, to learn the rules and routines of these activities, and provide guidance to photographers.

The photography recommendation system allows a photographer to choose the corresponding event and obtain an image capture plan that includes a series of sub-events, like a checklist for some indispensable sub-events of the event, as well as corresponding professional image examples. During the image capture procedure, the photography recommendation system evaluates the content of the images as they are captured, generates notifications that describe the possible content of the following images, obtains some quality image examples and their corresponding camera settings, and/or generates suggested camera settings. With the guidance of the photography recommendation system, even a beginner with a lack of photography experience may be able to become familiar with the event routine, capture the important scenes, and take some high-quality images.

The system includes a camera 1550, an event recognition module 1520, a recommendation module 1560, and image storage 1530. The camera 1550 captures one or more images 1510, and may receive a user selection of an event (e.g., though an interface of the camera 1550). The images 1510 and the event selection 1513, if any, are sent to the event recognition module 1520. The event recognition module 1520 identifies an event based on the received event selection 1513 and/or based on the received images and event models. The event recognition module may evaluate the received images 1510 based on one or more event models 1523 to determine the respective sub-event depicted in the images 1510. For example, the event recognition module 1520 may implement methods similar to the methods implemented by the annotation module to determine the sub-event depicted in an image. The event recognition module 1520 may also label the images 1510 with the respective determined sub-event to generate labeled images 1511. Also, based on the sequence and the content of the images 1510, the event recognition module 1520 may determine the current sub-event 1562 (e.g., the sub-event associated with the last image in the sequence). The event recognition module 1520 also retrieves the event schedule 1563 of the determined event (e.g., from the applicable event model 1523). The event recognition module 1520 sends the labeled images 1511, the event schedule 1563, and/or the current sub-event event 1562 to the recommendation generation module 1560.

The recommendation generation module 1560 then searches and evaluates images in the image storage 1530 to find example images 1564 for the sub-events in the event schedule 1563. The search may also be based on the labeled images 1511, which may indicate the model of the camera 1550, lighting conditions at the determined event, etc., to allow for a more customized search. For example, the search may search exclusively for or prefer images captured by the same or similar model of camera, in similar lighting conditions, at a similar time of day, at the same or a similar location, etc. Labels on the images in the image storage 1530 may be used to facilitate the search for example images 1564 by matching the sub-events to the labels on the images. For example, if the event is a birthday party, for the sub-event “presentation of birthday cake with candles” the recommendation generation module 1560 may search for images labeled with “birthday,” “cake,” and/or “candles.” Also, the search may evaluate the content and/or capture settings of the labeled images 1511 and the content, capture settings, and/or ratings of the example images 1564 to generate image capture recommendations, which may indicate capture settings, recommended poses of an image subject, camera angles, lighting, etc. The schedule, the image capture recommendations, and/or the example images 1561, which may include an indicator of the current sub-event 1562, are sent to the camera 1550, which can display them to a user.

A user may be able to send the event selection 1513 before the event begins, and the image recommendation system will return a checklist of all the indispensable sub-events, as well as corresponding image examples. Also, the user could upload the detailed schedule for the event, which can be used to facilitate sub-event recognition and expectation in the following sub-events of the event. A schedule of the sub-events can be generated manually, for example by analyzing customs and life experiences, and/or generated by a computing device that analyzes image collections for an event. The provided schedule may help a photographer become familiar with the routine of the event and be prepared to take images for each sub-event.

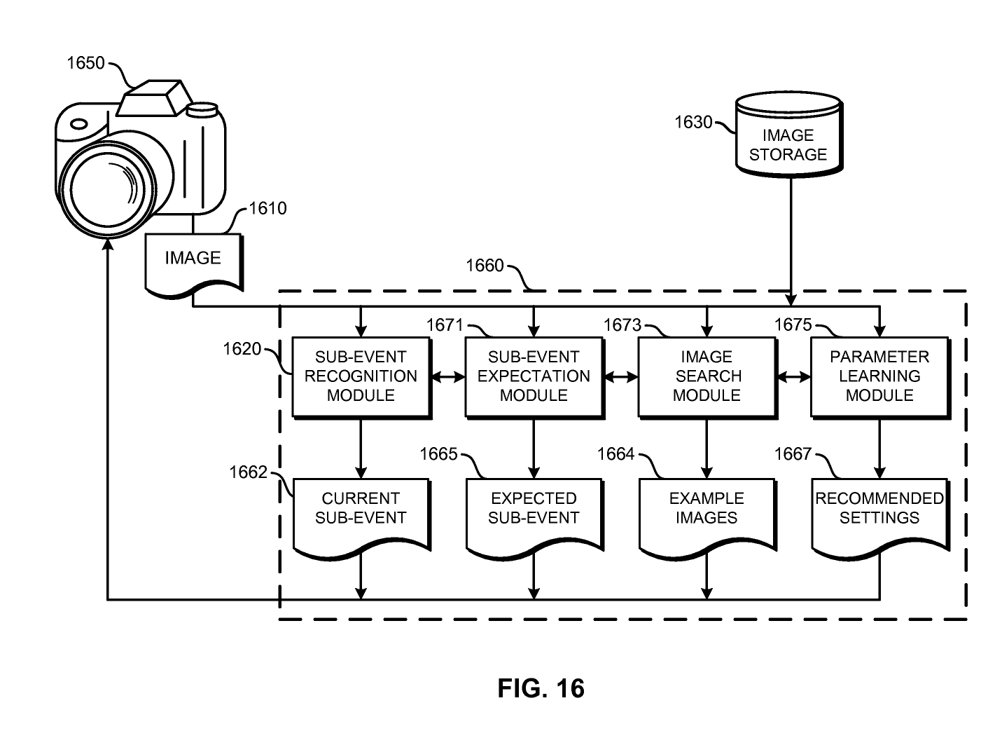

FIG. 16 illustrates an example embodiment of the flow of operations in a recommendation system. The recommendation system generates real-time or substantially real-time photography recommendations during an event.

Once an image 1610 is captured by a camera 1650, the image 1610 is sent to a recognition device 1660 for sub-event recognition. Using the sub-event recognition components and methods described above, which are implemented in the sub-event recognition module 1620, the recognition device 1660 can determine the current sub-event 1662 depicted by the image 1610 and return a notification to the user that indicates the current sub-event 1662. In order to provide real-time service, some distributed computing strategy (e.g., Hadoop, S4) may be implemented by the recognition device 1660/sub-event recognition module 1620 to reduce computation time.

The sub-event expectation module 1671 predicts an expected sub-event 1665, for example if the system gets positive feedback from a photographer/user (e.g., feedback the user enters through an interface of the camera 1650 or another device), as a default operation, if the system receives a request from the user, etc. The next expected sub-event 1665 can be estimated based on the transition probability aᵢⱼ in the applicable event model and on the current sub-event 1662. Thus, the expected sub-event 1665 can be estimated and returned to the camera 1650 by the recognition device 1660. In some embodiments, the transition probabilities can be dependent on the time-lapse between images. For example, if the previous sub-event (state) is “wedding kiss” but the next image taken is 10 minutes later, it is much less likely that the next state is still “wedding kiss.”

The image search module 1673 searches the image storage 1630 to find example images 1664 that show the current sub-event 1662 and/or the expected sub-event 1665. The image storage 1630 may include professional and/or high-quality image collections that were selected from massive online image repositories. The example images 1664 are sent to the camera 1650, which displays them to a user. In this manner, the user may get a sense of how to construct and select a good scene and view for an image of a sub-event.

The parameter learning module 1675 generates recommend settings 1667 that may include flash settings, exposure time, ISO, aperture settings, etc., for an image of the current sub-event 1662 and/or the expected sub-event 1665. The exact settings of one image (e.g., an example image) may not translate well to the settings of a new image (e.g., one to be captured by the camera 1650) due to variations in the scene and variations in illumination, differences in cameras, etc. However, based on the settings of multiple example images, such as flash settings, aperture settings, and exposure time settings, the parameter learning module 1675 can determine what settings should be optimized and/or what tradeoffs should be performed in the recommended settings 1667. The modules of the system may share their output data and use the output of another module to generate their output. For example, the parameter learning module 1675 may receive the example images 1664 and use the example images 1664 to generate the recommended settings 1667. The recognition device returns the current sub-event 1662, the expected sub-event 1665, the example images 1664, and the recommended settings 1667 to the camera 1650.

In some embodiments, a selected high-quality example image is examined to determine whether the example image was taken in a particular shooting mode. If the shooting mode is known and is a mode other than an automatic mode or manual mode, then the example image shooting mode is used to generate the recommended settings 1667. Such modes include, for example, portrait mode, landscape mode, close-up mode, sports mode, indoor mode, night portrait mode, aperture priority, shutter priority, and automatic depth of field. If the shooting mode of the example image cannot be determined or was automatic or manual, then the specific settings of the example image are examined so that the style of image can be reproduced. In some embodiments, the aperture setting is examined and split into three ranges based on the capabilities of the lens: small aperture, large aperture, and medium aperture. Example images whose aperture settings fall in the large aperture range may cause the recommended settings 1667 to indicate an aperture priority mode, in which the aperture setting is set to the most similar aperture setting to the example image. If the aperture of the example image was small, the recommended settings 1667 may include an aperture priority mode with a similar aperture setting or an automatic depth of field mode. If the aperture setting of the example image is neither large nor small, then the shutter speed setting is examined to see if the speed is very fast. If the shutter speed is determined to be very fast then a shutter priority mode may be recommended. If the shutter speed is very slow, then the parameter learning module 1675 could recommend a shutter priority mode with a reminder to the photographer/user to use a tripod for the shot. If the aperture and shutter settings are not extreme one way or the other, then the parameter learning module 1675 may include an automatic mode or an automatic mode with no flash (if the flash was not used in the example or the flash is typically not used in typical images of the sub-event) in the recommended settings 1667.

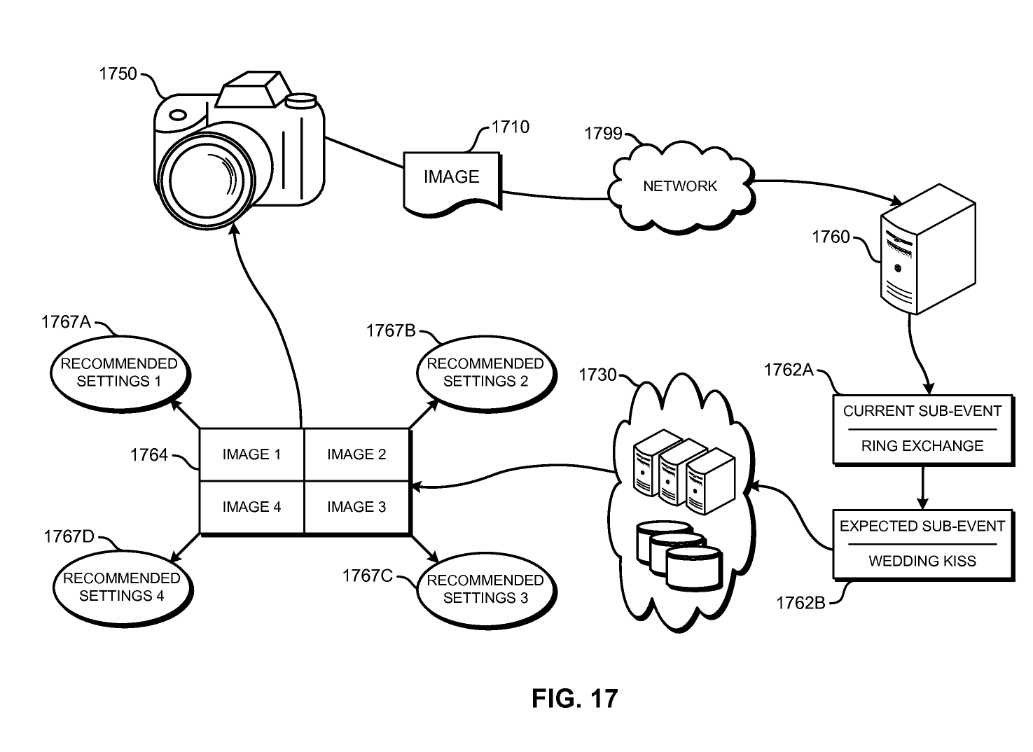

FIG. 17 illustrates an example embodiment of the flow of operations in a recommendation system. The recommendation system generates recommended settings 1767A-D, which may include a list of settings that can be ranked, so that the camera 1750 can capture multiple shots if the shutter button is continuously activated (e.g., held down). Therefore, the camera 1750 can quickly configure itself to the settings that are included in a series of settings so that a large variation of images is captured and the user can later select the best from the captured images.

For example, suppose that a user is shooting images for a wedding ceremony, and the current image 1710 depicts a “ring exchange” sub-event. The image 1710 captured by the camera 1750 is transmitted to a recommendation device 1760 via a network 1799. The recommendation device 1760 extracts the current sub-event 1762A from the current image 1710. Also, the recommendation device 1760 predicts the next expected sub-event 1762B, for example by analyzing an event model that includes a HMM for wedding ceremonies. Based on the HMM state transition probability, the recommendation device 1760 determines that the sub-event “ring exchange” is usually followed by the sub-event “wedding kiss.” The recommendation device 1760 searches for example images 1764 of a “wedding kiss” in the image storage 1730, which includes networked servers and storage devices (e.g., an online image repository). The recommendation device 1760 generates a list of recommended settings 1767A-D (each of which may include settings for multiple capabilities of the camera 1750, for example ISO, shutter speed, white balance, aperture) based on the example images 1764. For example, the recommendation device 1760 may add the settings that were used to capture image 1 of the example images 1764 to the first recommended settings 1767A, and therefore when the camera 1750 is set to the first recommended settings 1767A, the camera 1750 will be set to settings that are the same as or similar to the settings used by the camera that captured image 1.

The example images 1764 and their respective settings 1767A-D are sent to the camera 1750 by the recommendation device 1760. The camera 1750 may then be configured in an automatic recommended setting mode (e.g., in response to a user selection), in which the camera will automatically capture four images in response to a shutter button activation, and each image will implement one of the recommended settings 1767A-D. For example, if each of the recommended settings 1767A-D includes an aperture setting, a shutter speed setting, a white balance setting, an ISO setting, and a color balance setting, in response to an activation (e.g., a continuous activation) of the shutter button, the camera 1750 configures itself to the aperture setting, shutter speed setting, white balance setting, ISO setting, and color balance setting included in the first recommended settings 1767A and captures an image; configures itself to the aperture setting, shutter speed setting, white balance setting, ISO setting, and color balance setting included in the second recommended settings 1767B and captures an image; configures itself to the aperture setting, shutter speed setting, white balance setting, ISO setting, and color balance setting included in the third recommended settings 1767C and captures an image; and configures itself to the aperture setting, shutter speed setting, white balance setting, ISO setting, and color balance setting included in the fourth recommended settings 1767A and captures an image. The camera 1750 may also be configured to capture the images as quickly as the camera can operate.

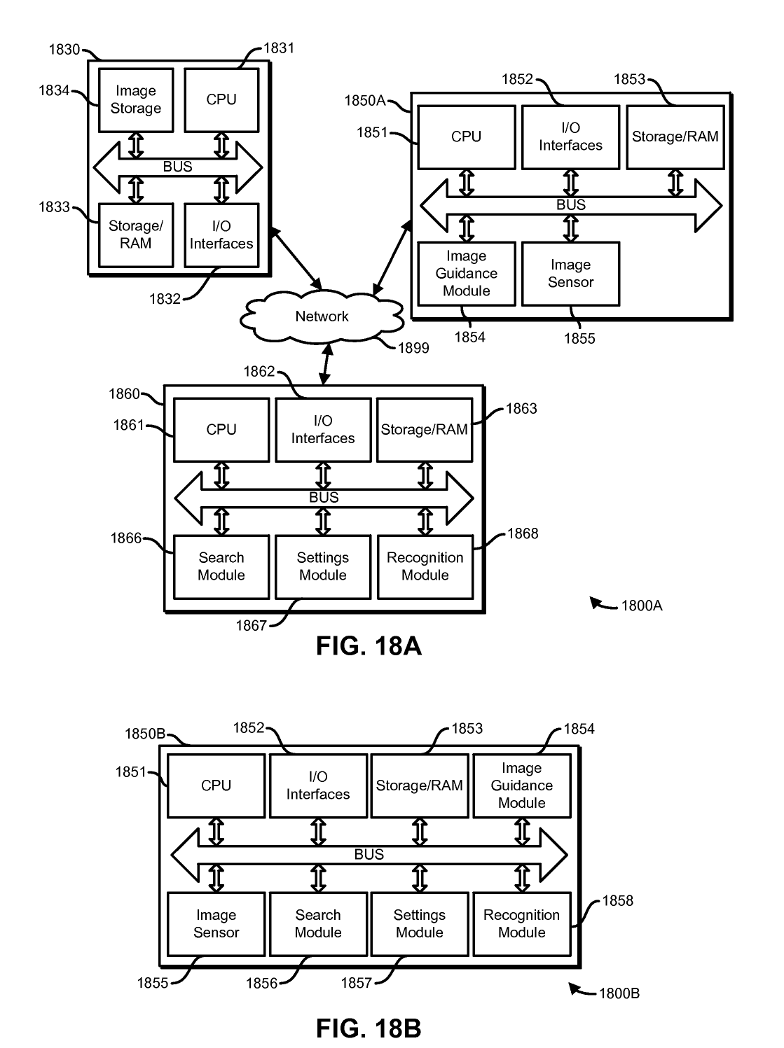

FIG. 18A illustrates an example embodiment of a recommendation system 1800A. The system 1800A includes a camera 1850A, a recommendation device 1860, and an image storage device 1830. The camera 1850A includes a CPU 1851, I/O interfaces 1852, storage/RAM 1853, an image guidance module 1854, and an image sensor 1855. The image guidance module 1854 includes computer-executable instructions that, when executed, cause the camera 1850A to send captured images to the recommendation device 1860 via the network 1899 and to receive and display one or more of the current sub-event, the expected sub-event, example images, and recommended settings from the recommendation device 1860. The image guidance module 1854 may also configure the settings of the camera 1850A to the recommended settings and may sequentially configure the settings of the camera 1850A to capture respective images in a sequence of images.

The recommendation device 1860 includes a CPU 1861, I/O interfaces 1862, storage/RAM 1863, a search module 1866, a settings module 1867, and a recognition module 1868. The recognition module 1868 includes computer-executable instructions that, when executed, cause the recommendation device 1860 to identify a current sub-event in an image based on the image and one or more other images in a related sequence of images, to determine an expected sub-event based on the current sub-event in an image and/or the sub-events in other images in a sequence of images, and to send the current sub-event and/or the expected sub-event to the camera 1850A. The search module 1866 includes computer-executable instructions that, when executed, cause the recommendation device 1860 to communicate with the image storage device 1830 via the network 1899 to search for example images of the current sub-event and/or the expected sub-event, for example by sending queries to the image storage device 1830 and evaluating the received responses. The settings module 1867 includes computer-executable instructions that, when executed, cause the recommendation device 1860 to generate recommended camera settings based on the example images and/or on the capabilities of the camera 1850A and to send the generated camera settings to the camera 1850A.

The image storage device 1830 includes a CPU 1831, I/O interfaces 1832, storage/RAM 1833, and image storage 1834. The image storage device is configured to store images, receive search queries for images, search for images that satisfy the queries, and return the applicable images.

FIG. 18B illustrates an example embodiment of a recommendation system 1800B. A camera 1850B includes a CPU 1851, I/O interfaces 1852, storage/RAM 1853, an image guidance module 1854, an image sensor 1855, a search module 1856, a settings module 1857, and a recognition module 1858. Thus, the camera 1850B of FIG. 18B combines the functionality of the camera 1850A and the recommendation device 1860 illustrated in FIG. 18A.

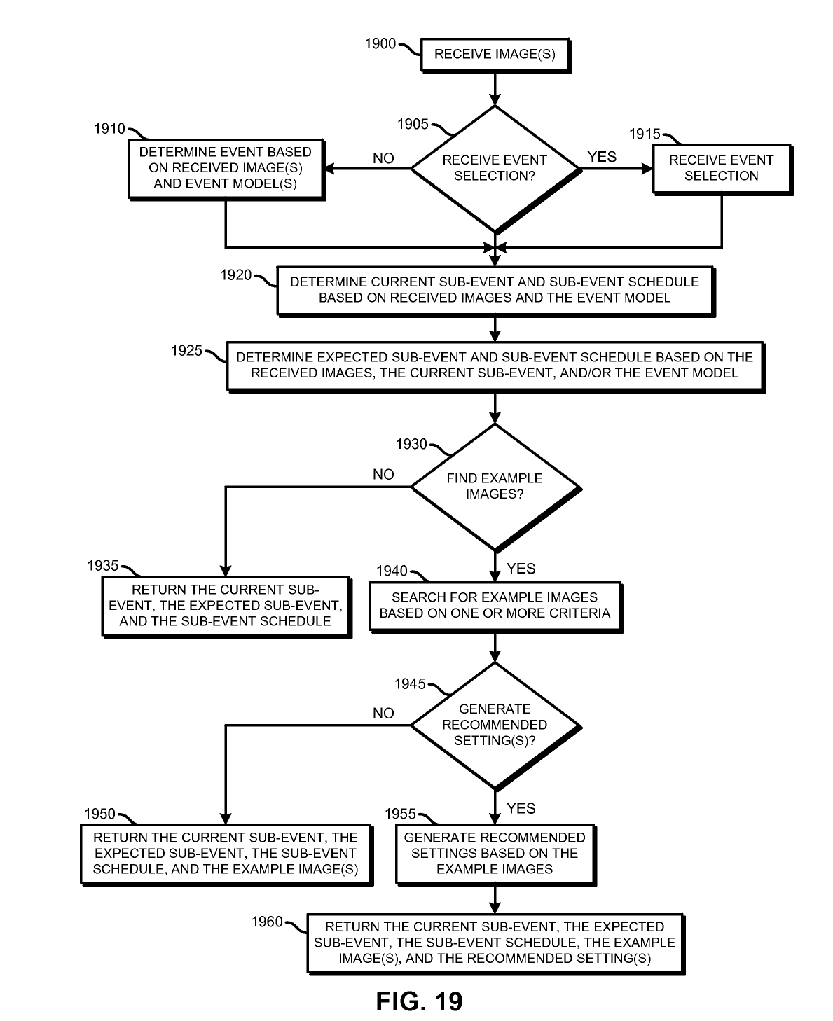

FIG. 19 illustrates an example embodiment of a method for generating image recommendations and examples. The flow starts in block 1900, where one or more images are received or captured (e.g., receive from a camera, captured by a camera). Next, in block 1905, it is determined if an event selection will be received (e.g., entered by a user). If no, the flow proceeds to block 1910, where the event is determined based on the received image(s) and stored event models, and then the flow proceeds to block 1920. If yes, the flow proceeds to block 1915, where an event selection is received, and the flow then moves to block 1920. In block 1920, the current sub-event is determined based on one or more of the received images (e.g., the most recently captured image, the most recently received image, the images in a series of images) and on the corresponding event model.

Next, in block 1925, the expected sub-event (e.g., the predicted subsequent sub-event) and the sub-event schedule are determined based on one or more of the current sub-event, the one or more received images, and the event model. Then in block 1930, it is determined if example images are to be found. If no, then the flow proceeds to block 1935, where the current sub-event, the expected sub-event, and/or the sub-event schedule are returned (e.g., sent to a requesting device and/or module). If yes, then the flow proceeds to block 1940, where example images are searched for based on one or more criteria, for example by the searching a computer-readable medium or by sending a search request to another computing device. After block 1940, the flow moves to block 1945, were it is determined if one or more recommended settings are to be generated. If no, the flow proceeds to block 1950, where the current sub-event, the expected sub-event, the sub-event schedule, and/or the example image(s) are returned (e.g., sent to a requesting device and/or module). If yes, the flow proceeds to block 1955, where one or more recommended settings (e.g., a set of recommended settings) are generated for the current sub-event and/or the expected sub-event, based on the example images. Block 1955 may include generating a series of recommended settings (e.g., multiple sets of recommended settings) for capturing a sequence of images, each according to one of the series of recommended settings (e.g., one of the sets of recommended settings). Finally, the flow moves to block 1960, where the current sub-event, the expected sub-event, the sub-event schedule, the example image(s), and/or the recommended settings are returned (e.g., sent to a requesting device and/or module).

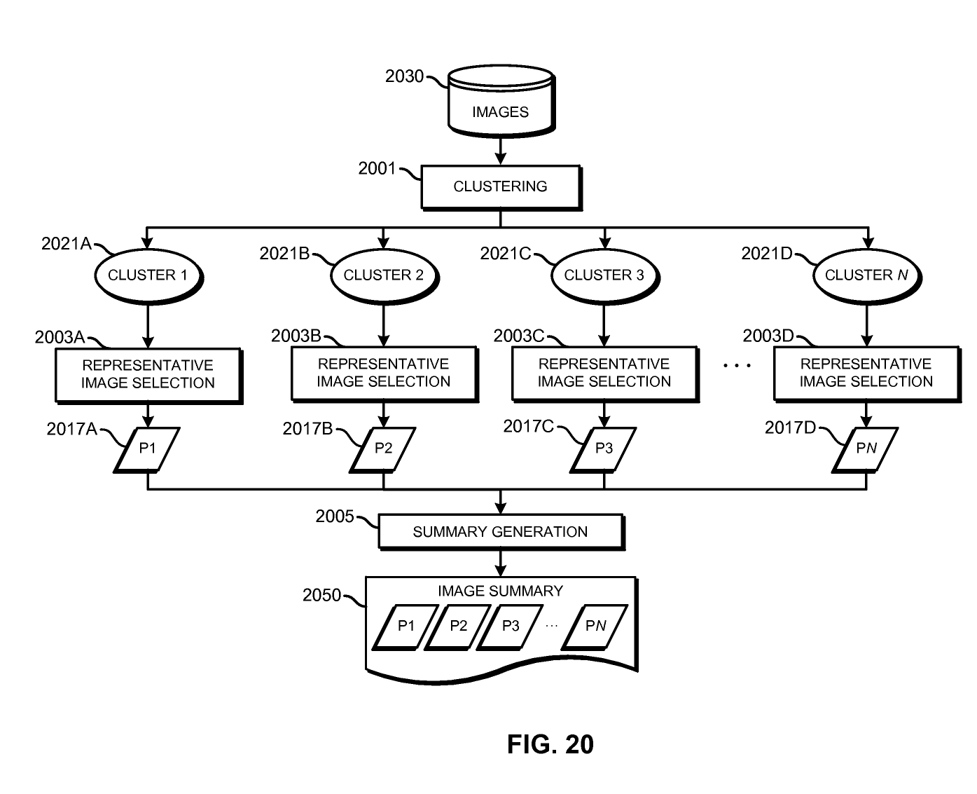

Also, images' sub-event information may be used to evaluate the image content, and the sub-event information and an event model may be used to summarize images. FIG. 20 illustrates an example embodiment of an image summarization method. The flow starts in block 2001, where images stored in the image storage 2030 are clustered to form clusters 2021, which include cluster 1 2021A to cluster N 2021D. The clusters 2021 may be generated based at least in part on sub-event labels associated with the images.

Next, in blocks 2003A-2003D, one or more representative images 2017, which include representative images 2017A-D, are selected for each of the clusters 2021. For example, representative image 2017A is selected for cluster 1 2021A. The flow then proceeds to block 2005, where an image summary 2050 is generated. The image summary 2050 includes the representative images 2017.

Also, image quality may be used as a criterion for image summarization. A good quality image may have a sharp view and high aesthetics. Hence, image quality can be evaluated based on objective and subjective factors. The objective factors may include structure similarity, dynamic range, brightness, contrast, blur, etc. The subjective factors may include people's subjective preferences, such as a good view of landscapes and normal face expressions. Embodiments of the method illustrated in FIG. 20 may consider both image semantic information and image quality to implement personal image summarization. In the clustering block 2001, one or more image clustering algorithms (e.g., affinity propagation) are applied to organize images into clusters of similar images. The features on which clustering is based can include low-level features, such as visual and contextual features, and high-level semantic features, such as sub-event labels. In the representative image selection block 2003A, one or more images are selected to represent a whole cluster. The selection may be based on a score that accounts for image content and/or image quality, and the images with the highest respective scores may be selected as the representative images for a cluster.

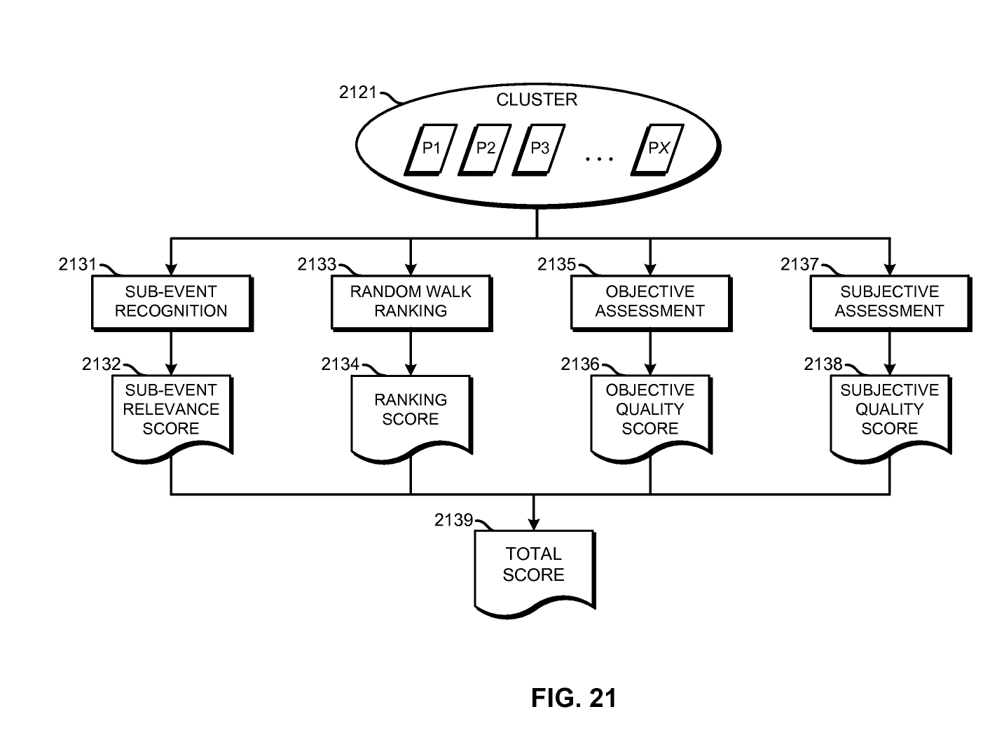

FIG. 21 illustrates an example embodiment of a method for generating a score for a representative image. Respective total scores 2139 are generated for one or more of the images in a cluster 2121 based on one or more scores, including a sub-event relevance score 2132, a ranking score 2134, an objective quality score 2136, and a subjective quality score 2138. In a sub-event recognition block 2131, the sub-event relevance score 2132 of an image i, denoted as ER(i), is generated. In a random-walk ranking block 2133, a ranking score 2134 Rank(i) of an image is generated. Additionally, an objective quality score 2136 Obj(i) is generated in an objective assessment block 2135, and a subjective quality score 2138 Subj(i) is generated in a subjective assessment block 2137. The total score 2139 of an image Ts(i) can be generated by combining these factors according to the following equation (8), where wᵢ refers to weights of each score, and w₁+w₂+w₃+w₄=1:

Ts(i)=w₁×ER(i)+w₂×Rank(i)+w₃×Obj(i)+w₄×Subj(i). (8)

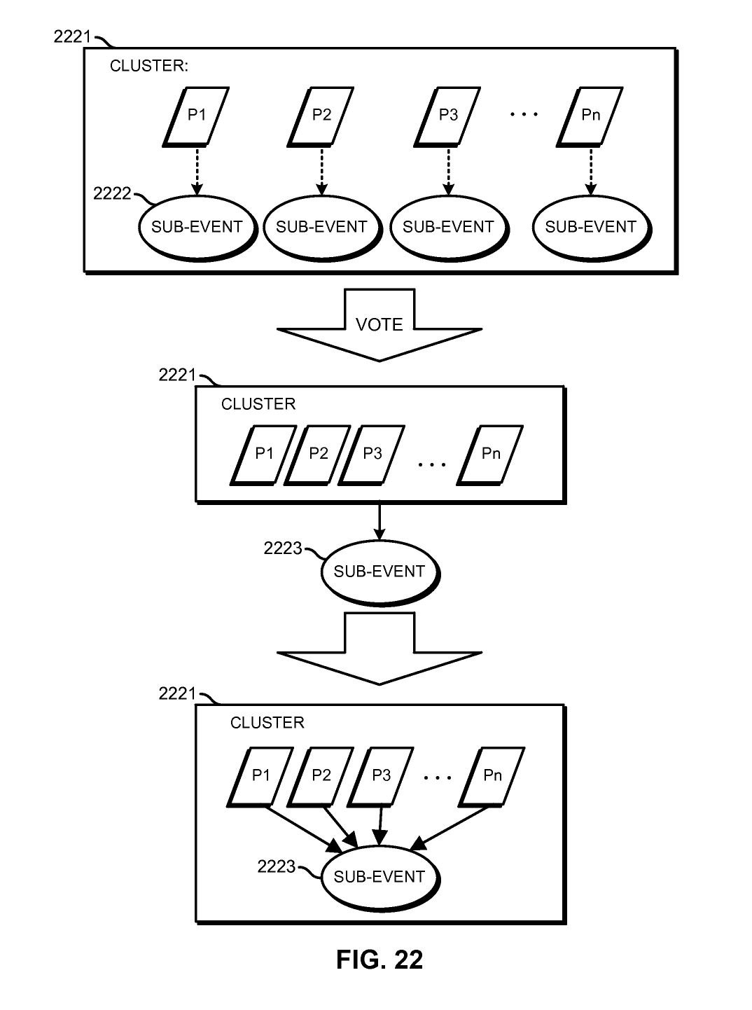

In the sub-event recognition block 2131, a sub-event relevance score (e.g., the probability of the image being relevant to a sub-event) is generated for each sub-events in an event model for each image in the cluster 2121, and the highest sub-event score for an image is assumed to be the sub-event conveyed in the image. Then, analyzing all the images in the cluster 2121, the most likely sub-event for the cluster 2121 can be determined, for example by a voting method. FIG. 22 illustrates an example embodiment of a method for determining the sub-event related to the images in a cluster of images. Respective highest sub-event scores 2222 are determined for the images P1 to Pn in a cluster 2221. Next, the most likely sub-event 2223 is determined for the cluster 2221 based on the highest sub-event scores 2222 of the images P1 to Pn. Finally, the images P1 to Pn in the cluster 2221 are associated with the most likely sub-event 2223. Once the most likely sub-event 2223 is determined, the sub-event relevance score ER(i) for the most likely sub-event 2223 is generated for each image in the cluster 2121.

Referring again to FIG. 21, in the random-walk ranking block 2133, an image similarity graph is constructed for the cluster 2121 based on the low-level features extracted from the images. The random-walk operations can be performed in a graph in order to rank the images and generate respective ranking scores Rank(i).

In the objective assessment block 2135, objective quality scores 2136 are generated for the images in the cluster 2121. Following are examples of objective image quality measures, and depending on the embodiment, a single object quality measure or any combination of the following objective quality measures is used to generate the objective quality scores 2136:
(1) Structural Similarity: A structural similarity index can be applied to luminance in order to evaluate image quality. The measure between two windows x and y of common size N×N is

$$SSIM ( x , y ) = \frac{( 2 {μ}_{x} {μ}_{y} + {c}_{1} ) ( 2 {σ}_{xy} + {c}_{2} )}{( {μ}_{x}^{2} + {μ}_{y}^{2} + {c}_{1} ) ( {σ}_{x}^{2} + {σ}_{y}^{2} + {c}_{2} )} , \qquad ( 9 )$$

where μₓ is the average of x; μ_{y} is the average of y; σₓ² is the variance of x; σ_{y}² is the variance of y; σ_{xy} is the covariance of x and y; and c₁=(k₁L)², c₂=(k₂L)² are two variables to stabilize the division with a weak denominator.
(2) Dynamic Range: Dynamic range (e.g., the ratio between the largest and smallest possible values of a changeable quantity), may be used to denote the luminance range of a scene being photographed. In some embodiments, the dynamic range is measured by the ratio of the p-th and 100 minus p-th percentiles to make the estimate more robust. In some embodiments, for example, the dynamic range is measured with the luminance standard deviation or median absolute difference from the median.
(3) Color Entropy: Color entropy can be used to describe the colorlessness of the image content.
(4) Brightness: Many low-quality images are photographed with insufficient light. Any one of a number of available algorithms can be used to calculate the brightness for each image.
(5) Blur: Any one of a number of blur detection algorithms can be used to calculate the blur in an image. For example, a wavelet transform may be used, and a measurement of blur can be extracted from the wavelet coefficients.
(6) Contrast: Good images generally have a strong contrast between the subject and the background. A number of available algorithms can be used compute the contrast. For example, luminance contrast can be defined as the ratio of luminance difference and average luminance.
(7) Sharpness: Sharpness determines the amount of detail an image can convey. Some available sharpness measures can be used to measure sharpness of an image.
   Each of the above-described object quality measures returns a score for an image, and an image's objective quality score 2136 Obj(i) may be a combination of these scores.

In the subjective assessment block 2137, a subjective quality score 2138 is generated. Subjective image quality is a subjective response based on both objective properties and subjective perceptions. In order to learn users' preferences, user feedback may be analyzed. Hence, for each sub-event, a corresponding image collection with evaluations from users can be constructed, and a new image can be assessed based on this evaluated image collection.

Additionally, other factors can be used to generate the subjective quality score 2138. For example, for images that include people, users typically prefer images with non-extreme facial expressions. Therefore, the criterion of facial expression for a people image may be considered. Furthermore, certain facial expressions and characteristics, such as smiles, are often desirable, while blinking, red-eye effects, and hair messiness are undesirable. Also, some of these qualities may depend on the particular context. For example, having closed eyes may not be a negative quality during the wedding kiss, but might not be desirable during the wedding vows.

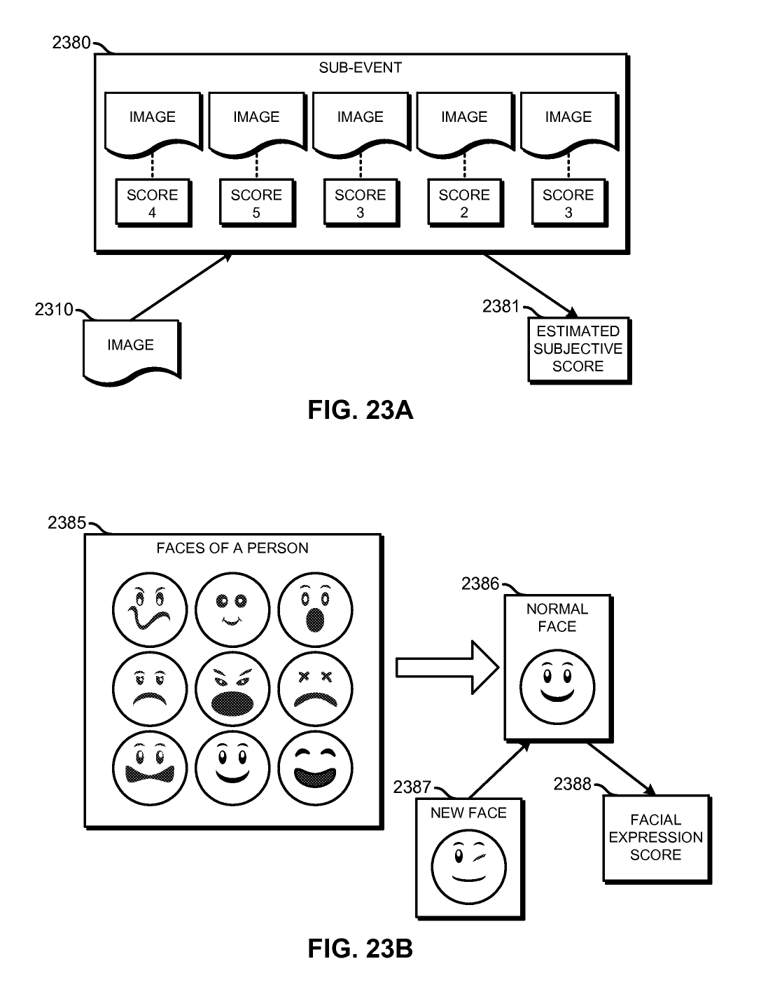

Therefore, the subjective quality score 2138 may be generated based on one or more of an estimated user's subjective score and a facial expression score. To generate an estimated user's subjective score, for each sub-event in a specific event, some example images regarding the sub-event can be collected and evaluated by users (which may include experts). A new image can be assessed based on the evaluated image collection. FIG. 23A illustrates an example embodiment of the generation of an estimated subjective score 2381 based on an image collection 2380 for a sub-event. If the sub-event is a “ring exchange,” an example image collection 2380 for “ring exchange” can be constructed from a collection of images that have been rated (from 1 to 5, for example) by users. Then to evaluate a new “ring exchange” image 2310, the similarity between this new image 2310 and the other images in the example image collection 2380 can be computed, and the K nearest neighbors' evaluation scores can be used to generate the estimated subjective score 2381 of the new image.

To generate a facial expression score, a normal face may be used as a standard to evaluate a new facial expression. FIG. 23B illustrates an example embodiment of the generation of a facial expression score 2388 based on a normal face 2386. To generate a cluster of the faces of a person 2385, a face detection system detects all the faces in images in a set of images and then clusters the faces into several clusters. In each cluster, the faces are assumed to belong to the same person, and thus a cluster of the faces of a person 2385 is assumed to include the faces of a particular person. Then using normalization techniques, a normal face 2386 of this particular person can be obtained. The normal face 2386 will be used as a standard face to evaluate other facial expressions. When a new face 2387 of the person is detected, the new face 2387 is compared with the normal face 2386 to generate a facial expression score 2388.

Therefore, for each image, an estimated subjective score 2381 and a facial expression score 2388 may be generated. The subjective quality score 2138 (Subj(i)) in FIG. 21 may be a combination of these two scores. Also, the estimated subjective score 2381 and/or the facial expression score 2388 may contain information about smiling, hair, blinking, etc. These factors can also be measured and combined with the facial expression to generate the subjective quality score 2138 Subj(i). In some example embodiments, a linear combination of these factors is used to generate a subjective quality score 2138 Subj(i) where the coefficients of the linear combination are determined by regression of the measured characteristics of user ratings of images of the same events. Thus it is possible to create a sub-event specific weighting of the factors based on large-scale user rated images.

Consequently, equation (8) can be used to combine the sub-event relevance score 2132, the ranking score 2134, the objective quality score 2136, and the subjective quality score 2138 to generate a total score 2139 for each image. The respective total scores 2139 can be used to rank the images in the cluster 2121 and to select one or more representative images.

Also, by combining semantic information with image quality assessment, the selected images for the image summary 2050 may be meaningful and have a favorable appearance. Additionally, the extracted event model for some specific event provides a list of sub-events as well as the corresponding order of the sub-events. For example, in a western style wedding ceremony, the sub-event “wedding vow” is usually followed by “wedding kiss,” and both of them may be indispensable elements in the ceremony. Thus, in an image summary 2050, images about “wedding vow” and “wedding kiss” may be important and may preferably follow a certain order. Therefore, the semantic labels of the images may make the summarization more thorough and narrative. In some embodiments, the importance of a sub-event is determined based on the prevalence of images for that sub-event found in a training data set. In some embodiments, the importance is determined based on an image-time density that measures the number of images taken of an event divided by the estimated duration of the event, which is based on the image time stamps in the training data set. In some embodiments, the importance of the sub-events can be pre-specified by a user.

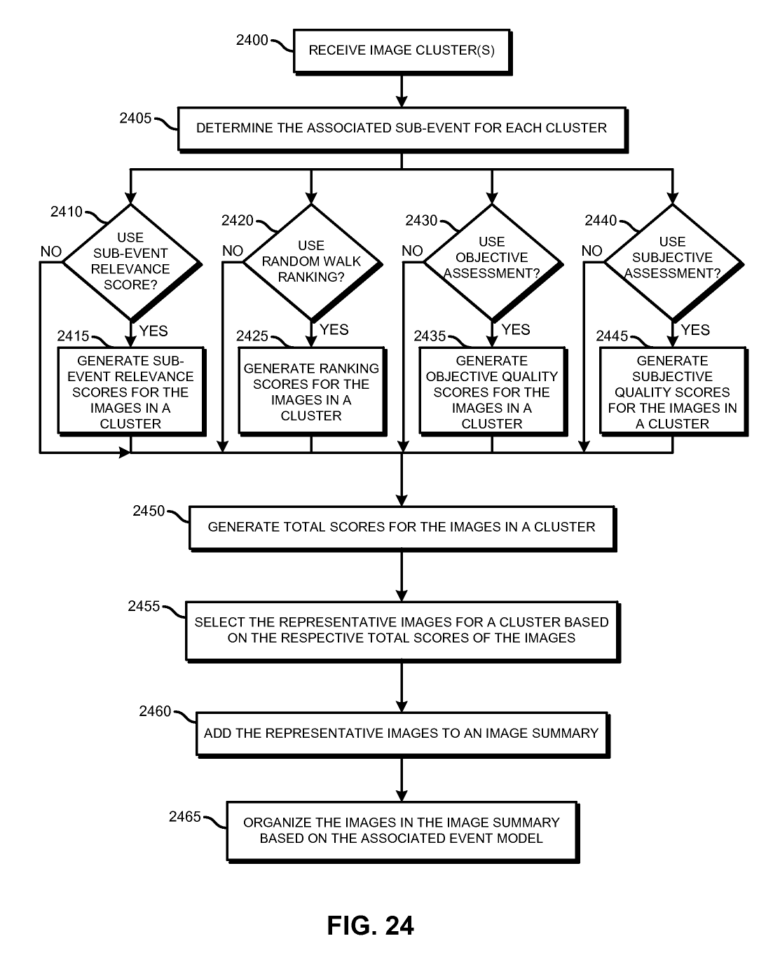

FIG. 24 illustrates an example embodiment of a method for selecting representative images. The flow starts in block 2400, where the images of one or more image clusters are received. Next, in block 2405, the associated sub-event for each cluster is determined. The flow then proceeds, either serially or in parallel, to blocks 2410, 2420, 2430, and 2440. In block 2410, it is determined if sub-event relevance scores will be used to generate the total scores. If no, the flow proceeds to block 2450. If yes, the flow proceeds to block 2415, where sub-event relevance scores are generated for the images in a cluster, and then the flow proceeds to block 2450.

In block 2420, it is determined if random-walk rankings will be used to generate the total scores. If no, the flow proceeds to block 2450. If yes, the flow proceeds to block 2425, where ranking scores are generated for the images in a cluster, and then the flow proceeds to block 2450.

In block 2430, it is determined if objective assessment will be used to generate the total scores. If no, the flow proceeds to block 2450. If yes, the flow proceeds to block 2435, where objective quality scores are generated for the images in a cluster, and then the flow proceeds to block 2450.

In block 2440, it is determined if subjective assessment will be used to generate the total scores. If no, the flow proceeds to block 2450. If yes, the flow proceeds to block 2445, where subjective quality scores are generated for the images in a cluster, and then the flow proceeds to block 2450.

In block 2450, the respective total scores for the images in a cluster are generated based on any generated sub-event relevance scores, ranking scores, objective quality scores, and subjective quality scores. Next, in block 2455, representative images are selected for a cluster based on the respective total scores of the images in the cluster. The flow then proceeds to block 2460, where the representative images are added to an image summary. Finally, in block 2465, the images in the image summary are organized based on the associated event model, for example based on the order of the respective sub-events that are associated with the images in the image summary.

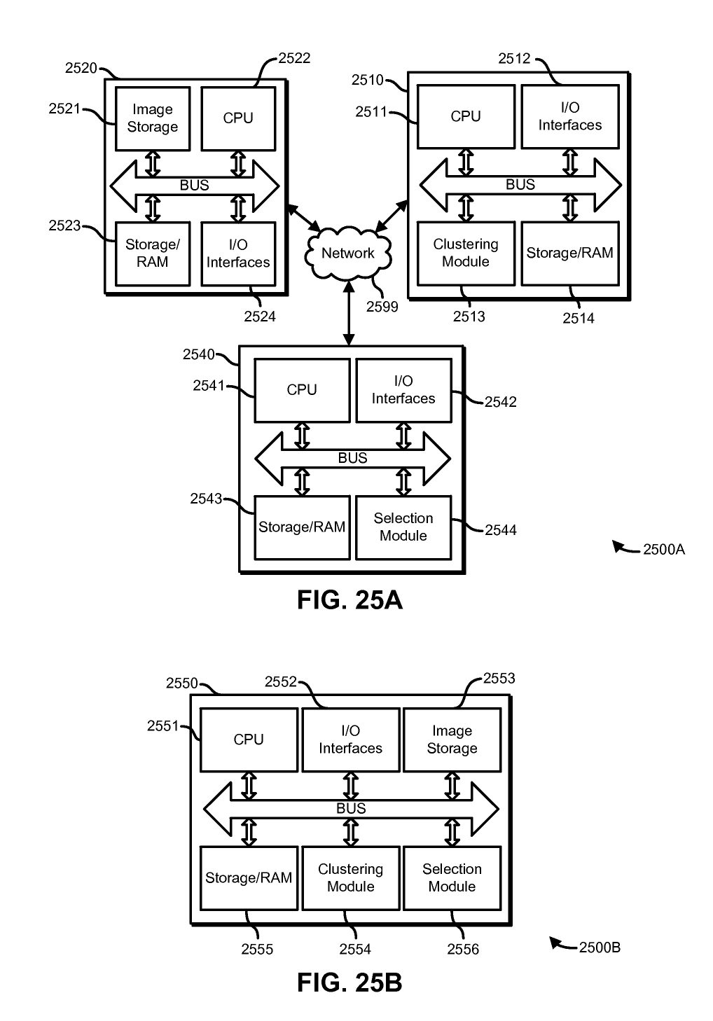

FIG. 25A illustrates an example embodiment of an image management system 2500A. The system 2500A includes an image storage device 2520, a clustering device 2510, and a selection device 2540, which communicate via a network 2599. The image storage device 2520 includes a CPU 2522, I/O interfaces 2524, storage/RAM 2523, and image storage 2521. The image storage device 2520 is configured to add images to the image storage 2521, delete images from the image storage 2521, receive search queries for images, search for images that satisfy the queries, and return the applicable images.

The clustering device 2510 includes a CPU 2511, I/O interfaces 2512, storage/RAM 2514, and a clustering module 2513. The clustering module 2513 includes computer-executable instructions that, when executed, cause the clustering device 2510 to obtain images from the image storage device 2520 and generate image clusters based on the obtained images.

The selection device 2540 includes a CPU 2541, I/O interfaces 2542, storage/RAM 2543, and a selection module 2544. The selection module 2544 includes computer-executable instructions that, when executed, cause the selection device 2540 to select one or more representative images for one or more clusters, which may include generating scores (e.g., sub-event relevance scores, ranking scores, objective quality scores, subjective quality scores, total scores) for the images.

FIG. 25B illustrates an example embodiment of an image management system 2500B. A selection device 2550 includes a CPU 2551, I/O interfaces 2552, storage/RAM 2555, image storage 2553, a clustering module 2554, and a selection module 2556. Thus, the selection device 2550 of FIG. 25B combines the functionality of the image storage device 2520, the clustering device 2510, and the selection device 2540 illustrated in FIG. 25A.

The above described devices, systems, and methods can be implemented by supplying one or more computer-readable media having stored thereon computer-executable instructions for realizing the above described operations to one or more computing devices that are configured to read the computer-executable instructions and execute them. In this case, the systems and/or devices perform the operations of the above-described embodiments when executing the computer-executable instructions. Also, an operating system on the one or more systems and/or devices may implement the operations of the above described embodiments. Thus, the computer-executable instructions and/or the one or more computer-readable media storing the computer-executable instructions thereon constitute an embodiment.

Any applicable computer-readable medium (e.g., a magnetic disk (including a floppy disk, a hard disk), an optical disc (including a CD, a DVD, a Blu-ray disc), a magneto-optical disk, a magnetic tape, and a solid state memory (including flash memory, DRAM, SRAM, a solid state drive)) can be employed as a computer-readable medium for the computer-executable instructions. The computer-executable instructions may be written to a computer-readable medium provided on a function-extension board inserted into the device or on a function-extension unit connected to the device, and a CPU provided on the function-extension board or unit may implement the operations of the above-described embodiments.

The scope of the claims is not limited to the above-described embodiments and includes various modifications and equivalent arrangements.

What is claimed is:

1. A method comprising:
extracting low-level features from an image of a collection of images of a specified event, wherein the low-level features include visual characteristics calculated from the image pixel data, and wherein the specified event includes two or more sub-events;
extracting a high-level feature from the image, wherein the high-level feature includes characteristics calculated at least in part from one or more of the low-level features of the image;
identifying a sub-event in the image based on the high-level feature and a predetermined model of the specified event, wherein the predetermined model describes a relationship between two or more sub-events; and
annotating the image based on the identified sub-event.

2. The method of claim 1, wherein identifying the sub-event in the image is further based at least in part on a respective sub-event score of the image that is based on the low-level features.

3. The method of claim 2, wherein the sub-event score is a sub-event probability.

4. The method of claim 3, wherein the sub-event probability based on the low-level features is determined using a probability mixture model trained with a second collection of sub-event-labeled images.

5. The method of claim 2, wherein the low-level features are represented with a lower dimensional representation, wherein the dimensionality of the low-level features in the lower dimensional representation is reduced using principal component analysis.

6. The method of claim 1, wherein the low-level features include one or more of a color-based feature, a texture-based feature, an edge-based feature, and a local image descriptor.

7. The method of claim 1, wherein the low-level features include one or more of time, geo-location, ISO setting, aperture, exposure, focus, flash, camera mode, and camera model.

8. The method of claim 1, wherein the high-level feature is an adjusted time, a classifier-based location determination, a face detection, a face clustering, or an activity determination.

9. The method of claim 1, wherein identifying the sub-event further comprises:
training a hidden Markov model using a second collection of ordered sub-event-labeled images; and
estimating a sub-event sequence from the hidden Markov model.

10. The method of claim 1, further comprising choosing representative images of the sub-event from a plurality of images in the collection of images for inclusion in an image summary collection.

11. A system for organizing images, the system comprising:
at least one computer-readable medium configured to store images; and
one or more processors configured to cause the system to
extract low-level features from a collection of images of an event, wherein the specified event includes one or more sub-events;
extract a high-level feature from one or more images based on the low-level features;
identify one or more sub-events corresponding to one or more images in the collection of images based on the high-level feature and a predetermined model of the event, wherein the predetermined model defines the one or more sub-events; and
label the one or more images based on the recognized corresponding sub-events.

12. The system of claim 11, wherein the predetermined model of the event describes one or more of a temporal order of sub-events and respective high-level features that are associated with the one or more sub-events.

13. The system of claim 12, wherein the respective high-level features that are associated with the one or more sub-events include one or more of location of an image, time an image was captured, people in an image, non-people objects in an image, and activities in an image.

14. The system of claim 11, wherein the system uses a Hidden Markov Model to recognize the one or more sub-events, wherein observed states correspond to high-level features and unobserved states correspond to the sub-events.

15. One or more computer-readable media storing instructions that, when executed by one or more computing devices, cause the one or more computing devices to perform operations comprising:
quantifying low-level features of images of a collection of images of an event;
quantifying one or more high-level features of the images based on the low-level features; and
associating images with respective sub-events based on the one or more high-level features of the images and a predetermined model of the event that defines the sub-events.

16. The one or more computer-readable media of claim 15, wherein the operations further comprise training the predetermined model of the event based on a training set of images that are labeled according to the sub-events.

17. The one or more computer-readable media of claim 15, wherein the operations further comprise modeling respective relationships between the low-level features and the sub-events, and wherein the images are associated with the respective sub-events based on the respective relationships between the low-level features and the sub-events.

18. The one or more computer-readable media of claim 15, wherein the operations further comprise selecting respective representative images for the sub-events.

19. The one or more computer-readable media of claim 15, wherein the operations further comprise locating example images of the respective sub-events.

20. The one or more computer-readable media of claim 15, wherein the operations further comprise generating a series of camera setting groups for an expected sub-event based on the example images, wherein each camera setting group includes one or more setting parameters that are different from the settings in the other camera setting groups.
